(19) United States
(12) Patent Application Publication
(10) Pub. No.: US 2025/0176473 A1
(43) Pub. Date: Jun. 5, 2025

(54) SYSTEMS AND METHODS FOR AGRICULTURAL RISK MANAGEMENT

(71) Applicant: Mars, Incorporated, McLean, VA (US)

(72) Inventors: Donna HENDERSON, McLean, VA (US); Jean-Philippe MARELLI, McLean, VA (US); Jerome NIOGRET, McLean, VA (US)

(21) Appl. No.: 18/868,033

(22) PCT Filed: May 25, 2023
(86) PCT No.: PCT/US2023/023524

§ 371 Date: Nov. 21, 2024

Related U.S. Application Data
(60) Provisional application No. 63/345,859, filed on May 25, 2022.

(51) Int. Cl. A01G 7/06; A01G 23/00; G06Q 10/0635; G06Q 50/02

(52) U.S. Cl. CPC A01G 7/06; A01G 23/00; G06Q 10/0635; G06Q 50/02

(57) ABSTRACT

Methods and systems for managing risks for agricultural systems include receiving an agricultural system unit (ASU) selection for an ASU associated with an agroforestry agricultural system, and accessing an analysis for a plant corresponding to the ASU selection based on a selection type of the ASU selection. An assessment associated with the plant corresponding to the ASU selection may be accessed based on the analysis and the selection type, and a need for a risk mitigating technique based on the analysis and/or the assessment may be determined. Results of processing the ASU selection may be indicated in a graphical user interface (GUI) based on the selection type. Plants of the agroforestry agricultural system may include cocoa trees.

### CROSS-REFERENCE TO RELATED APPLICATION(S)

This application claims the benefit of priority from U.S. Provisional Application No. 63/345,859, filed on May 25, 2022, which is incorporated by reference herein in its entirety.

### TECHNICAL FIELD

This disclosure relates generally to systems and methods for managing risk of loss of agricultural products on various scales. In particular, the present disclosure is directed to systems and methods for managing risk in the agricultural production of plants and plant parts, such as cocoa beans.

### BACKGROUND

The fermented beans of Theobroma cacao are the primary ingredient in chocolate and grow from trees in pods. However, despite the economic importance of cacao beans, growing cocoa trees at scale presents many challenges due, at least in part, to cocoa agricultural systems being agroforestry agricultural systems. Unlike agricultural systems (e.g., farms) that grow row crops, cocoa agricultural systems are divided into non-uniformly shaped area-units (e.g., hectares) for which conditions affecting the growth of cocoa trees can be comparably non-uniform. As a result, growing cocoa trees at scale, even on just one cocoa farm, may require using diverse farming techniques and constant attention on sub-areas of agricultural systems subject to different growing conditions similar to the diversity of conditions one might see between areas in a forest.

In addition to the challenges mentioned above, cocoa trees are vulnerable to different pests and diseases, and typically grow in different regions of the world in remote and difficult-to-access locations. In particular, many cocoa agricultural systems around the world are found in areas that often have sub-optimal: (a) access to technology; (b) infrastructure; and/or (c) opportunities to acquire information on gain access to advanced or even generally accepted current farming techniques that may mitigate the risk of disease to tree plants, like cocoa (e.g., cocoa swollen shoot disease (CSSD)). Cacao beans worldwide are grown primarily on small family farms, with the rest grown on larger scale commercial cocoa growing operations. This is particularly the case on small agricultural systems where cocoa trees are grown. However, small agricultural system or large, all system operators (e.g., farmers) of cacao face unique challenges in managing agricultural risks from pests and diseases.

With particular respect to pests, cocoa cultivation is susceptible to various pests, and their identification plays a crucial role in implementing effective pest management strategies. Additionally, certain cacao pests are capable of traveling long distances, making localized mitigation challenging.

This disclosure is directed to addressing above-referenced challenges. The background description provided herein is for the purpose of generally presenting the context of the disclosure. Unless otherwise indicated herein, the materials described in this section are not admitted to be prior art, or suggestions of the prior art, by inclusion in this section.

### SUMMARY OF THE DISCLOSURE

According to certain aspects of the disclosure, techniques described herein relate to methods and systems for managing risks for agricultural systems that may include receiving an agricultural system unit (ASU) selection for an ASU associated with an agroforestry agricultural system; accessing an analysis for a plant corresponding to the ASU selection based on a selection type of the ASU selection; accessing an assessment associated with the plant corresponding to the ASU selection based on the analysis and the selection type; determining a need for a risk mitigating technique based on the analysis and/or the assessment; and causing results of processing the ASU selection to be indicated in a graphical user interface (GUI) based on the selection type, wherein plants of the agroforestry agricultural system include cocoa trees.

In some aspects, the techniques described herein relate to systems and methods for managing risk in agricultural systems that may include: configuring results of accessing the analysis and the assessment according to a specified format based on at least one of a location of the agroforestry agricultural system or a reporting standard; accessing assessments includes determining a number of plants within an ASU exhibiting a disease, such as cocoa swollen shoot disease; accessing assessments includes receiving an indication of a test result from a test kit; accessing assessments includes generating a heat map including a density indicator; and a density indicator being configured to indicate a number of plants included in an ASU.

In some aspects, the techniques described herein relate to systems and methods for managing risk in agricultural systems that may include: capturing an image of at least a portion of an ASU of an ASU selection, and receiving an image analysis for the image, the image analysis including a number of plant parts that are damaged within the portion of an ASU.

In some aspects, the techniques described herein relate to systems and methods for managing risk in agricultural systems that may include: determining a need for a risk mitigating technique that includes determining a risk mitigating technique includes changes to a schedule for analyzing at least one group of plants included in an agroforestry agricultural system, and transmitting a notification to at least one computing device, the notification including the schedule with the changes; determining a need for a risk mitigating technique includes accessing historical weather information from one or more servers, the historical weather information being for an area including an agroforestry agricultural system, and determining the risk mitigating technique includes changing a schedule for supplying of water to at least a portion of the agroforestry agricultural system based on the historical weather information.

In some aspects, the techniques described herein relate systems and methods for managing risk in agricultural systems that may include: results of processing an ASU selection including a prediction for an incidence of at least one disease in at least one group of plants in an agroforestry agricultural system over a defined future period of time, the prediction having been made using a prediction model for the agroforestry agricultural system; and causing the results of processing an ASU selection to be indicated in a GUI includes causing the GUI to include a summary for an ASU, the summary including a number of plants associated with the ASU that are diseased for a single date or over a range of dates.

In some aspects, the techniques described herein relate systems and methods for managing risk in agricultural systems that may include a computer system including at least one memory storing instructions, and at least one processor configured to execute the instructions to perform operations including: receiving an agricultural system unit (ASU) selection for an ASU associated with an agroforestry agricultural system; accessing an analysis for a plant corresponding to the ASU selection based on a selection type of the ASU selection; accessing an assessment associated with the plant corresponding to the ASU selection based on the analysis and the selection type; determining a need for a risk mitigating technique based on the assessments; and causing results of processing the ASU selection to be indicated in a graphical user interface based on the selection type, wherein plants of the agroforestry agricultural system include cocoa trees.

In some aspects, the techniques described herein relate systems and methods for managing risk in agricultural systems that may include a non-transitory computer-readable medium storing instructions that, when executed by at least one processor, cause the at least one processor to perform operations including: receiving an agricultural system unit (ASU) selection for an ASU associated with an agroforestry agricultural system; accessing an analysis for a plant corresponding to the ASU selection based on a selection type of the ASU selection; accessing an assessment associated with the plant corresponding to the ASU selection based on the analysis and the selection type; determining a need for a risk mitigating technique based on the assessments; and causing results of processing the ASU selection to be indicated in a graphical user interface based on the selection type, wherein plants of the agroforestry agricultural system include cocoa trees.

It is to be understood that both the foregoing general description and the following detailed description are exemplary and explanatory only and are not restrictive of the disclosed examples.

### BRIEF DESCRIPTION OF THE DRAWINGS

The accompanying drawings, which are incorporated in and constitute a part of this specification, illustrate various exemplary examples and together with the description, serve to explain the principles of the disclosed examples.

FIG. 1 depicts a flowchart of an exemplary method for managing risk in agricultural systems, according to one or more examples.

FIG. 2 depicts a sequence diagram of an exemplary method for managing risk in agricultural systems, according to one or more examples.

FIG. 3 depicts a flowchart of an exemplary method for identifying agricultural risk mitigation techniques, according to one or more examples.

FIG. 4 depicts exemplary system components for managing risks in agricultural systems, according to one or more examples.

FIG. 5 depicts an illustration of an exemplary graphical user interface (“GUI”) used to implement various methods described herein.

FIGS. 6A and 6B depict illustrations of exemplary GUIs for defining profiles of agricultural system units (ASUs), according to one or more examples.

FIG. 6C depicts an illustration of an exemplary GUI for summarizing a profile of an agricultural system, according to one or more examples.

FIGS. 7A and 7B depict illustrations of exemplary GUIs related to scouting agricultural systems, according to one or more examples.

FIG. 8A depicts an illustration of an exemplary GUI related to accessing different assessments for an agricultural system, according to one or more examples.

FIGS. 8B and 8C depict illustrations of exemplary GUIs for different assessments related to an agricultural system, according to one or more examples.

FIGS. 9A and 9B depict illustrations of exemplary GUIs for selecting a type of agricultural system report, according to one or more examples.

FIG. 9C depicts an illustration of an exemplary GUI for an exemplary agricultural system report, according to one or more examples

FIG. 10 depicts an illustration of an exemplary GUI related to analyzing ASUs, according to one or more examples.

FIG. 11 depicts an illustration of an exemplary GUI used to implement various methods described herein.

### DETAILED DESCRIPTION

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), (B and B), etc. Relative terms, such as, “substantially” and “generally,” are used to indicate a possible variation of ±10% of a stated or understood value.

According to certain aspects of the present disclosure, methods and systems are disclosed herein for managing risks of plant loss in agricultural systems due to disease, pests (e.g., insects), and weather-related issues. Some agricultural systems, such as cocoa farms, are agroforestry agricultural systems that present unique issues when attempting to optimize plant yield. Many agroforestry agricultural systems are characterized in terms of hierarchical levels of agricultural system units (“ASU” or “ASUs”) ranging from a single plant to an entire agricultural system (e.g., a farm, group of farms, growing region). More specifically, in some examples, an ASU may be defined, in order of size and/or number of plants, as: a plant; an area-unit (e.g., a hectare) of plants; a block (e.g., a field) of area-units; a sector of blocks; an agricultural system (e.g., farm) of sectors; and a region including one or more agricultural systems.

While some agricultural systems including certain types of plants (e.g., row crops such as corn) may be divided into ASUs of substantially uniform shape at an area-unit level, agroforestry agricultural systems (e.g., cocoa tree farms) may be divided into non-uniformly shaped area-units (e.g., hectares) and resemble natural forests. In some aspects, agroforestry agricultural systems may be comprised of different areas that use or are exposed to light and nutrients at different levels. Furthermore, agroforestry agricultural systems may define land-use systems that involve deliberate use of trees, shrubs, or other woody perennials with agricultural crops and/or animals, and may require careful analysis and consideration of limitations before plant introduction. In addition, many of these types of systems must be uniquely designed and managed to diversify and sustain production, increase social, economic, and environmental benefits, and reduce production costs and risks.

A general risk to agroforestry agricultural systems that may be particularly difficult to combat due to the forest-like nature of these systems, is that of asymptomatic diseases and asymptomatic spread thereof. This may be due to the variety of ways in which plants of the same type may respectively present, even within the same ASU such as a block, making identification of diseased plants very difficult. Even if one plant is identified as having a disease, knowing the spread of such a disease within a respective (agroforestry) agricultural system may be nearly unknowable until full manifestation of the disease has occurred. Some indicators may include the presence of certain insects or fungi on or around plants, but system operators cannot consistently rely on such “catching in the act” types of identifications for a comprehensive risk mitigation strategy.

Examples of agroforestry agricultural systems may include cocoa farms, which may be characterized as having hills, rivers, animals, and other factors that affect where/how cocoa trees are planted. For the purposes of the present disclosure, the terms “cocoa” and “cacao” are considered as synonyms. Consistent with other agroforestry agricultural systems, cocoa trees are not like corn or other row plants where area-units (e.g., hectares) are normally uniformly shaped (e.g., in squares). With cocoa in particular, non-uniformity extends to how these plants look as well as how cocoa is planted, harvested, and processed.

More specifically, cocoa is a unique plant that includes flowers and pods that grow from trunks of cocoa trees, rather than from branches. The pods can be red, purple, yellow, or orange in color and do not fall from the trunks of the trees. Pods have to be physically cut off, which generally involves us of a machete, even on large scale farms. This is because automated harvesting solutions are not typically effective for trunk based pod growing plants such as cocoa.

Processing is another area in which cocoa trees are unique. Pods must be opened to access and remove cocoa beans that are surrounded by pulp. Then, the cocoa beans must undergo a fermentation process in which whole beans are fermented in pulp. This is an initial and indispensable step in the cocoa beans eventually yielding a flavor that most think of with chocolate. Fermentation may involve completely different processes depending on the area of the world in which the cocoa beans were harvested. For example, in West Africa, fermentation may be done by putting beans in giant piles and covering them with banana leaves. On the other hand, in equatorial regions such as Ecuador, fermentation is accomplished by putting piles cocoa beans out in the sun.

Cocoa trees may also be subject to asymptomatic diseases that can result in catastrophic plant loss. For example, one disease that can be found in cocoa trees is cocoa swollen shoot disease (CSSD), which may be caused by a host of different viruses. A critical, and devastating aspect of CSSD, is the disease's propensity to spread asymptomatically. In some situations, cocoa trees with CSSD can be asymptomatic for up to two years. However, once symptoms of CSSD appear, an entire agricultural system (e.g., farm) may have to be burned or otherwise destroyed because no cure exists for the disease, which kills infected trees and may spread quickly and broadly. In fact, CSSD is considered by some to pose the greatest threat to cocoa in the world.

For example, in some areas of West Africa, loss of cocoa trees due to CSSD has been estimated at more than 70% of the total number of cocoa trees therein. System operators (e.g., farmers) around the world report long periods of misdetection coupled with attempts to control CSSD-causing viruses through application of insecticides or replanting too soon only to have seedlings infected by the same virus. CSSD has also proven to have devastating impacts on the livelihoods in the regions of the world where cocoa trees are grown. Tree loss in these areas have led to: the reduction of expenditures in key areas such as education, food, and health; limiting mobility of people and their capacity to obtain credit and support their families; reducing the number of meals people are able to obtain and thereby affecting food security and nutrition; as well as impacting young people whose schooling may have been cut short due to lack of funds and the need for older children to contribute to income generation.

Methods and systems described herein may be particularly effective in overcoming some of the unique challenges presented by agroforestry agricultural systems, including cocoa tree agricultural systems. In agroforestry agricultural systems, plant farming may be susceptible to various pests, and their identification plays a crucial role in implementing effective pest management strategies. Methods and systems described herein may provide user-friendly solutions that may be tailored according to a region in which a plant is found (such as Southeast Asia, South and Central America West Africa where cocoa trees may be found), and assist system operators to identify insect and pests that damage plants, such as cocoa trees.

In addition, system operators and agricultural experts alike may be able to utilize the exemplary methods and systems described herein to access comprehensive information sources (e.g., databases) on insects that may affect a specific plant and be prevalent in a specified area. Methods and systems described herein may also provide real-time information on appearance, behavior, and potential damage caused by pests, and thereby enable system operators to quickly and accurately identify the specific insects affecting their plants, such as cocoa trees. Furthermore, methods and systems described herein may provide localized recommendations for pest control methods and preventive measures that are specifically suited to a region's climatic conditions and agricultural practices that highly govern the pest outbreaks. Utilization of the tailored methods and systems described herein may provide system operators, such as cocoa farmers, with access to relevant and timely information, and empower them to make informed decisions to protect their plants and increase yield.

In some examples, methods and systems according to the present disclosure may provide exemplary risk management platforms configured to: (1) collect, process, analyze, organize and integrate, characterize and re-characterize, and present in one or more forms, pest, disease, weather, and plant condition data; and (2) assist in the management of integrated pest and disease risks to agricultural systems. Thus, aspects of the present disclosure are directed to methods and systems that are particularly suited for managing agricultural systems for growing plants, such as agroforestry agricultural systems including tree crops.

In addition, aspects of the present disclosure are directed to methods and systems that are particularly suited for managing smallholder agricultural systems with non-standardized farm layouts, sizes, and agricultural practices. Aspects of the present disclosure are directed to methods and systems for managing large scale agricultural systems including plants comprised primarily of tree crops in either agroforestry or full sun systems such as those located in, for example, tropical regions of the world. Aspects of the present disclosure are directed to methods and systems that are particularly suited for managing plants vulnerable to pests that disperse over substantial distances and or may be difficult to identify. Aspects of the present disclosure include a comprehensive database specifically designed for each region. Such comprehensive databases may be repositories for region specific information including: definitional/identification-based information regarding insects, pests, and diseases that are prevalent in a respective region and/or respective areas within the region and specific to respective plants therein; real-time information regarding recorded insect, pest, and disease presence; real-time information for pests, which may include details on the appearance, behavior, and potential damage caused by these insects and other pests; historical and real-time localized recommendations for pest control methods and preventive measures that are specifically suited to a respective region's climatic conditions and agricultural practices that may highly govern pest outbreaks.

Accordingly, methods and systems described herein may be configured or otherwise designed to manage risks in growing tree crops and protect yield in such crops that may be selected from the genera Theobroma or Herrania or inter- and intra-species crosses thereof within those genera, and more preferably from the species Theobroma cacao and Theobroma grandiflorum. One of ordinary skill in the art will recognize that the species Theobroma cacao may include all genotypes, particularly all commercially useful genotypes, including but not limited to Criollo, Forastero, Trinitario, Arriba, Amelonado, Contamana, Curaray, Guiana, Iquitos, Maranon, Nacional, Nanay and Purus, and crosses and hybrids thereof.

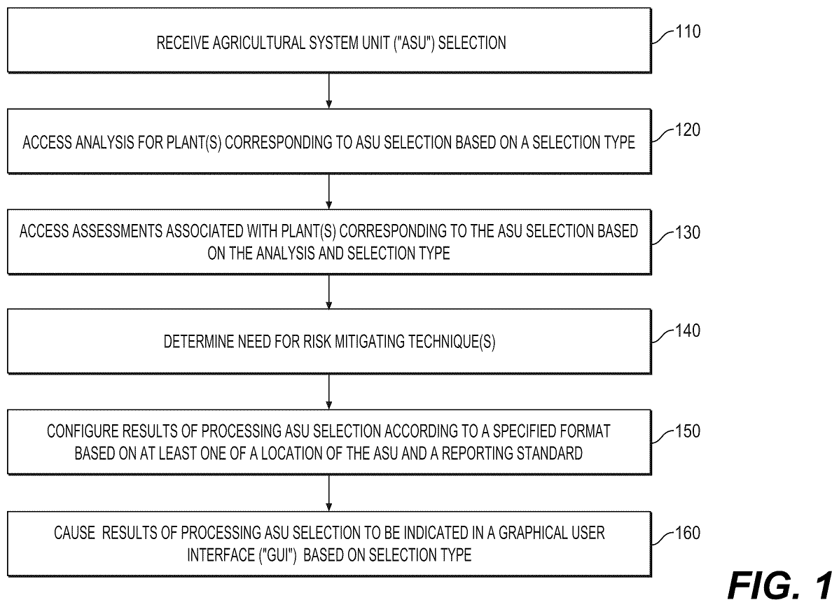

FIG. 1 depicts a flowchart of an exemplary method for managing risk in agricultural systems, according to one or more examples. In step 110, an agricultural system unit (“ASU”) selection may be received. In some examples, receiving the ASU selection may include receiving a selection of a plant, an area-unit, a block, a sector, a farm, or a region. In some examples the ASU may be displayed for selection in a user interface implemented by a computing device. According to some aspects of the present disclosure, a computing device may include a processor, a memory storage, and a non-transitory computer-readable medium containing instructions that are executed by the processor.

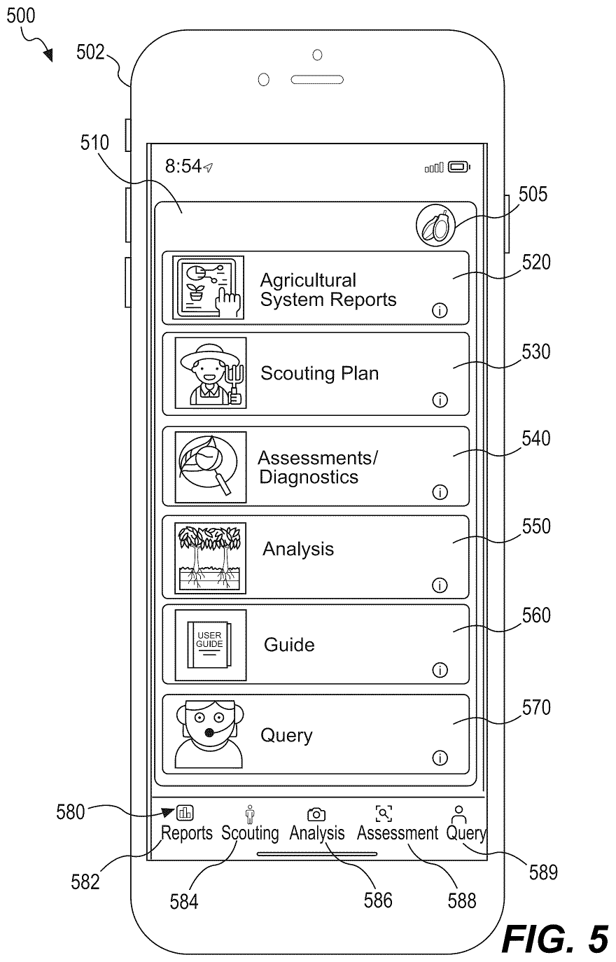

In addition to a type of ASU, the ASU selection received in step 110 may specify a selection type. More specifically, an interface through which the ASU selection is received may be implemented by a risk management agent executing on the computing device through which the ASU selection was received. In some examples, a selection type may correspond to a module being implemented by an exemplary risk management agent and/or a context in which the ASU was selected. As described in more detail with respect to FIGS. 5-11, exemplary modules may include, but are not limited to reporting, scouting, assessment, analysis, and query modules.

In some examples, a risk management agent according to the present disclosure may be part of, or configured to be compatible with, a software product that is: installed on a computing device; provided through a web application executing in a browser running on a computing device; and/or implemented on a computing device through an application programming interface (“API”). With any of the implementations for a software product associated with an exemplary risk management agent mentioned above, the software product may be at least partially provided by a processor associated with a risk management platform implemented through a backend. In some examples, such a backend may include one or more computing devices, such as one or more servers, and each computing device for the platform may include a processor, a memory storage, and a non-transitory computer-readable medium containing instructions that are executed by the processor.

Exemplary software products implemented via an exemplary backend may be configured to instantiate, update, maintain, or otherwise support aspects of a risk management platform, risk management agent, or portions/modules thereof, and may provide tools for: mapping out a scouting path; integrating new plant or ASU analyses into overall assessment information for the plant or the ASU, and higher level ASUs including the plant or higher-level ASU, such as an entire agricultural system; distributing notifications to workers for an agricultural system in addition to any and all system operators (e.g., farmers); generating visualizations (e.g., heat maps) of an agricultural system that reflect diseased plants; generating static, conditional, and/or operation-dependent user interface components and/or selectable options provided through an exemplary risk management agent; and other relevant features.

At step 120, the exemplary method may include accessing an analysis for a plant or plants corresponding to an ASU of the ASU selection in step 110 based on a selection type. According to aspects of the present disclosure, as it relates to data, a protocol, an analysis, an assessment, a recommendation, a mapping service, or other element, the term “accessing” may encompass: transmitting, as in transmitting a computer-implemented call for stored information; initiating, as in initiating one or more functions of a software product or a computing service, such as a plant analyzing service; connecting, as in connecting to a database or an external or other type of information source; and displaying, as in displaying locally or remotely stored information such as individual plant analyses, ASU assessments/assessment maps, and/or reports. Accessing may include other functions that may generally result in: the generation and/or presentation of additional data generally, and the generation and/or presentation of additional data related to an ASU selected at step 110. The term “accessing” may also encompass performing the function or objective that follows the term.

In one example, accessing an analysis in step 120 may include determining, a transmitting a request for, or otherwise initiating an exemplary process for analyzing a plant or group of plants that may be the subject of an ASU selection in step 110. Such a process for analyzing may be incorporated through the use of a camera to view or capture an image or video, or accessing a stored image or video. In addition, accessing an exemplary analysis may further include loading, transmitting, uploading, or otherwise providing a view, an image, or a video through a plant analysis service.

In some examples, a plant analysis service may be provided through a web-application, an API integrated into a risk assessment agent or tool for a risk management platform, or other type of software product that may be a stand-alone product that an exemplary risk management platform is configured to exchange data with. In other examples, a plant analysis service may be embodied as a module within a portion of a risk management platform, such as a risk management agent. Furthermore, a plant analysis service initiated by accessing of an analysis in step 120 may be configured to analyze, at one time, or through a series of analysis processes, a single plant, several plants, or groups of plants defining a higher-level ASU, such as an area-unit. In some examples, an analysis process may include some type of optical or other type of scan of a plant or a group of plants (or insects or pests). In still other examples, an analysis process utilized by a plant analysis service may incorporate the use of LIDAR sensors.

In some examples, accessing an analysis may include initiating or requesting via, e.g., an electronic communication, an execution of a plant analysis, for example by a plant analysis service. Such a plant analysis service may incorporate pest management and/or plant entomology services that may be directly or indirectly implemented by, or included in, or in communication with an example risk management platform or risk management agent according to the present disclosure. Initiating an execution of such a plant analysis may generate information regarding, or detect or recognize values for tracked parameters associated with, one or more plants. Such tracked parameters may include: a number of plant parts that may be damaged; an amount of a plant or plant parts (e.g., leaf, trunk, branch, pod, etc.) appearing to exhibit some level of damage; presence of one or more insects at a time when an analysis is conducted; weather characteristics such as if it is raining; an amount of sun exposure or lack thereof; a degree of moisture present in an environment surrounding the one or more plants; a degree of moisture exhibited in parts of one or more plants; colors of particular plant parts (e.g., color of pods of a cocoa tree); plant size; plant age; presence or absence of pesticides, chemicals, or the like; air temperature; and other aspects that may be detected or otherwise identified and/or potentially tracked for a plant, several plants, and/or an environment in which the plant or several plants are located. According to one or more aspects of the present disclosure, parameters associated with an analysis that may be accessed in step 120, may include parameters that may be used to diagnose whether or not a plant is diseased (e.g., exhibits CSSD).

In some examples, the of accessing an analysis that may include an execution of an analysis as mentioned above may include, for example a plant analysis by a pest management or entomology service implemented by, or included in, or in communication with an example risk management platform or risk management agent according to the present disclosure, and may generate information regarding, or detect or recognize values for tracked parameters associated with, one or more insects or other pests. Such insect or pest characteristics accessed in step 120 may include patterns of damage to the plant, such as chewed leaves, stunted growth, discolored leaves, spotted leaves, deformed plant parts, wilting or yellowing, gall formation, boreholes/tunnels, and or fruit damage or combinations thereof. The analysis can help identify pests such as cocoa pod borer, mirids, bark and ambrosia beetles, moths, aphids, white flies, or mealybugs or combinations thereof.

In one example, accessing an analysis in step 120 may include determining and implementing a protocol with respect to previously conducted analyses that may be stored on a server or other computing device of a risk management platform according the present disclosure. In some examples, a risk assessment agent being implemented on a computing device that initially received an ASU selection in step 110 may access a processor or service implemented on a backend with an identification of an ASU of the ASU selection to determine if an analysis for the ASU was previously conducted within a predetermined amount of time. In other examples, as specified by the backend, the risk assessment agent may temporarily store a predetermined amount of analysis information of a predetermined age, in a memory or storage component of the computing device implementing the risk assessment agent. Accordingly, the risk assessment agent may access this temporary cache of information and determine whether the ASU was previously analyzed within a specified amount of time. In instances in which an analysis meeting a specified time limitation is available, in a computing device used by an operator or a processor of a backend, the exemplary method of FIG. 1 may load the analysis in step 120. Otherwise, an analysis may be conducted as previously mentioned.

In step 130, the exemplary method may include accessing assessments associated with a plant or group of plants corresponding to the ASU selection based on the analysis and the selection type. In one example, an assessment may include a package of information that may be processed, as part of the accessing in step 130, to generate a visual representation of: a general status of one or several plants; an analysis of one or several plants; or a summary of analysis-related and/or diagnosis-related information for an ASU of the ASU selection or ASUs including the ASU of the ASU selection at step 110. In some examples, an assessment may include a visual representation that presents data included in the package of information in the context of one or more maps and/or types of maps.

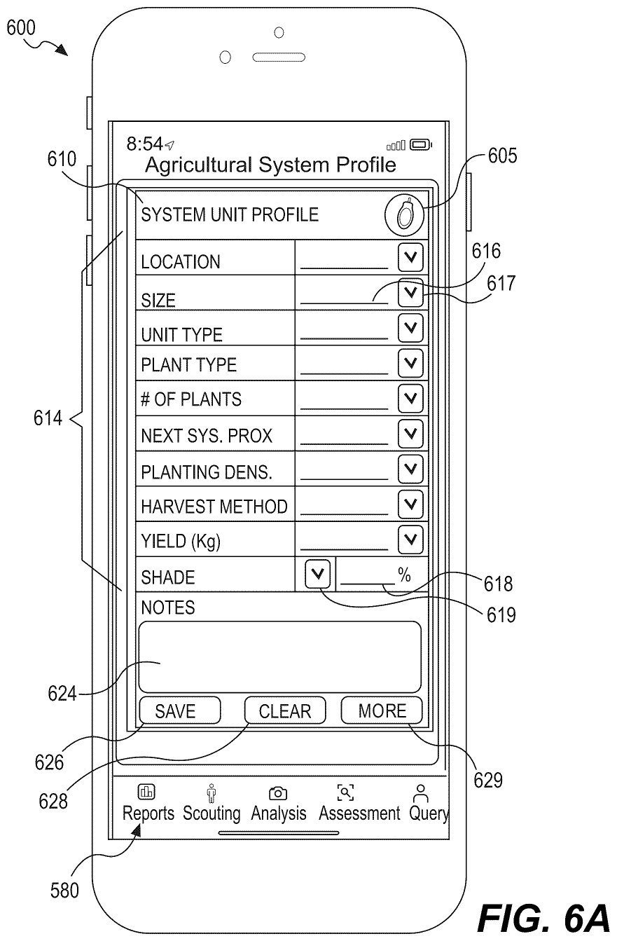

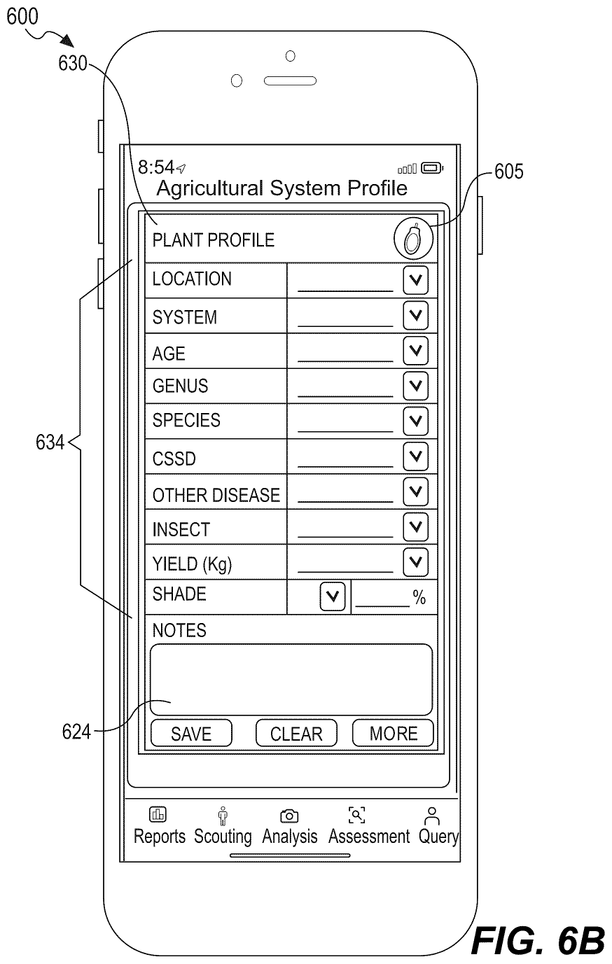

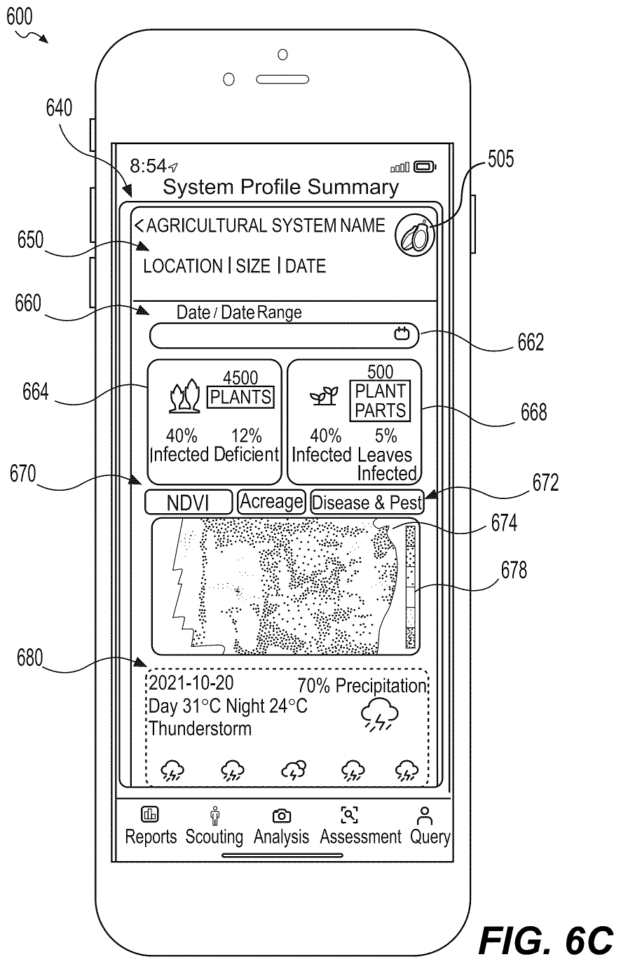

As described in more detail with reference to FIGS. 6A-6C, an assessment may include a heat map, a dot density map, or the like. In particular, such an assessment may provide a map of an agricultural system with different portions of the map presented differently relative to other to reflect a magnitude of a presence or absence of a plant, insect, pest, or parameter associated with plants within physical areas of an agricultural system corresponding to respective portions of the map. In some examples, an assessment may include one or more maps with different portions illustrated with different colors, densities of graphical elements, or the like to indicate: varying numbers of plants; varying numbers of one or more types of plants relative to numbers of one or more other types of plants; varying numbers of diseased plants; varying levels of pests and insects; varying levels of plant yield; and other measures of magnitude that may be associated with growing one or more types of plants.

In one example, accessing assessments in step 130 may include generating an assessment based on an analysis accessed in step 120. In other examples, accessing assessments in step 130 may merely include incorporating information generated from accessing an analysis in step 120 into an information package for an assessment. For example, accessing an analysis in step 120 may include conducting an analysis for a previously analyzed plant and values of one or more parameters for the analysis changing from the previous analysis. In such an example, accessing an assessment in step 130 may include updating corresponding aggregate parameter values for all ASUs that include the plant where parameter values changed.

At step 140, the exemplary method may include determining a need for one or more risk mitigating techniques based on the results of accessing analyses and assessments in steps 120 and 130. More specifically, information from an example analysis accessed in step 120 for an ASU may be processed, interpreted, or otherwise used to determine if a plant or more than one plant requires further evaluation. In another example, results of the analysis may be used by a risk management platform in a diagnostic process in step 140 that may identify a plant or several plants corresponding to an ASU selection as diseased, at risk of becoming diseased, subject to deleterious pest activity, and/or damaged from applications of pesticides, for example. In another example, results of the analysis used by the risk management platform in step 140 may identify pests new to an area.

A determination at step 140 may be made through one or more operations of an exemplary backend for an exemplary risk management platform according to the present disclosure. In one or more examples, the exemplary method may include identifying a disease exhibited by a plant or plants or pest damage exhibited by a plant or plants within a higher level ASU. In addition, a severity, or progression of the disease or pest damage, may be determined or estimated in step 140.

In addition, step 140 may include identifying any risk mitigating techniques that may address a disease exhibited or presence of pests and insects identified. In some examples, this may include accessing a database or other information source that includes tables, catalogues, or otherwise indexed data pertaining to risk mitigating techniques for growing plants. Subsequent to accessing such an information source, an exemplary risk management platform, or a risk management agent being implemented on a computing device used by a system operators, may execute a series of look-up or requests, and receive processes that result in a diagnosis (including disease severity or pest identification being matched to one or more risk mitigating techniques. In an example, there may be a reporting function to identify pests or diseases new to agricultural system or region. In an example, databases include information on potential risks associated with pests, including their behavior, preferred habitats, and plants they are known to infest, as well as best practices for preventive actions and biosecurity methods to implement. In an example, less pesticide, fungicide, or other chemical treatments may be needed because the information provided allows for targeted interventions by the system operators directed to the pest or disease present, and, for large scale agricultural systems, intervention only in the parts of the agricultural system requiring treatment.

In step 150, results from processing the ASU selection received at step 110 may be configured based on at least one of a location of the ASU selected in step 110 and a reporting standard. Results of processing the ASU selection may include data obtained, modified, validated, or otherwise processed through accessing one or more analyses and/or one or more assessments in steps 120 and 130, and/or determining a need for risk mitigating techniques and/or risk mitigating techniques needed in step 140. Step 150 may include one or more processors recognizing an initial format of such data, and any differences from formats that may be specified for historical analysis and assessment records based on a location of an agricultural system including the ASU selected, or a reporting standard established by an organization or some type of governing body associated with a type of plant included in the ASU selected at step 110.

In some examples, a location of the ASU may determine how data, and/or any information derived therefrom, is formatted in step 150 for the purposes of dissemination, in some form, to an operator or other worker for an agricultural system where the selected ASU is located. This may include formatting elements such as units of measure, file type, language, categories of data, characterizations of data associated with one ASU relative to data for other ASUs (e.g., a hierarchy), and the like. Such formatting elements may be specific to areas of the world where a selected ASU is located and take into account or otherwise reflect, for example, reporting standards established, communication protocols used, data restrictions enforced, data transfer limitations persisting, and/or languages spoken in a region of the world where the selected ASU is located.

Such data mentioned above may or may not eventually be presented in one form or another to an operator or other worker for an agricultural system via, for example, a computing device. However, depending on a type of plant associated with the ASU selected in step 110, reporting requirements established by a governing body or organization may dictate (alone or in addition to location-based formatting specifications) a format (e.g., units of measure, language, category of data, characterization relative to data for other ASUs (e.g., a hierarchy)) for new and/or updated analysis and assessment information and/or identified risk mitigating needs and/or techniques that result from processing the ASU selection. Thus, step 150 may include one or more processes in which data resulting from accessing one or more analyses and/or assessments in steps 120 and 130 and/or determining risk mitigating needs, and/or techniques needed, may be processed, matched to certain data fields, and formatted based on due diligence and sustainability reporting standards for importation of certain products and materials, including plants such as cocoa and its derivatives.

According to some aspects of the present disclosure, information accessed in steps 110 to 140, which may include capturing, processing, preparing for display, storing, analyzing, and/or updating the underlying data associated with the information accessed, may be further processed in step 150 according to reporting standards established by various organizations. Such standards may be established to ensure responsible cultivation practices, particularly in areas where oversite is logistically cumbersome. This may include agricultural systems in remote locations of the world where access to various technologies is limited and/or cultivation and record keeping practices may be carried out with equipment no longer in use in many if not most parts of the world and/or manually. However, systems and methods described herein may enable distribution, capture, and standardized formatting of data pertaining to cultivation in remote locations of plants, such as cocoa trees, using baseline technologies (e.g., cellular phones) that are available to many if not most individuals living in areas where subject agricultural systems are located.

Reporting standards, such as those alluded to above, may be aimed at eliminating or reducing negative impacts of plant production/processing/supply on the environment and issues concerning human rights. Actors in plant supply chains, such as cocoa supply chains, may be charged with focusing their efforts on ensuring and being able to demonstrate that plant by-products produced, processed, and supplied from a particular location are substantially free of deforestation and human rights abuses. Public and private regulatory mechanisms that enable reliable and transparent traceability of plants grown, processed, and supplied from certain locations around the world, may promote compliance and correct non-compliance. A level of reporting that may be facilitated by exemplary processes performed in step 150, and which may be standardized across various implementations of exemplary platforms described herein, may effectively contribute to reducing deforestation practices, reducing carbon footprints of certain plants such as cocoa, and ensuring humane treatment of and working conditions for individuals employed in various plant cultivation industries, such as the cocoa industry, for example.

At step 160, the exemplary method may include causing results of processing an ASU selection received in step 110 to be indicated in a graphical user interface (“GUI”) based on a selection type previously identified by a risk management agent and/or a processor of a backend of a risk management platform according to the present disclosure. In one example, the GUI may be provided through an interface (e.g., a screen) of a computing device on which a risk management agent may be executing or otherwise be implemented thereon. The GUI may be displayed on a computing device and, depending on a selection type associated with an ASU selection in step 110, may represent: an analysis of a plant or higher-level ASU including the plant; an assessment of a selected ASU or ASUs including the selected ASU; a report relating to a selected ASU or ASUs including the selected ASU; a scouting map for a selected ASU or ASUs including the selected ASU; a profile summary of a selected ASU or ASUs including the a selected ASU (including a system profile); or a module directed towards risk mitigating techniques or searching for risk mitigating techniques curated from a larger group of techniques based on an ASU of an ASU selection in step 110. As will be described in more detail with respect to FIGS. 5-11, elements of a GUI in which results of processing an ASU selection are indicated in step 160 may provide a range of information directed toward managing risk of plant loss for an agricultural system including the ASU selected in step 110.

The exemplary method of FIG. 1, in combination with exemplary computing devices configured to implement the method, provides an integrated solution that may aid in the identification and management of agricultural risks, and thereby effectively serve as an assistant to an agricultural system operator. In addition, exemplary risk management platforms described herein may be particularly well-suited to mitigate plant loss and optimize plant yield in agroforestry agricultural systems, such as cocoa farms. This may be due, in part, to a capability to deliver such risk management platforms with technology that is available in remote locations with limited access to technologies more advanced and/or complex than a cellular phone or other computing devices, handheld or otherwise, of similar complexity (e.g., tablets, laptops, etc.). Exemplary risk management methods and systems according to the present disclosure may be uniquely flexible to the extent that any platform described herein may be tailored to different types of plants (e.g., perennials), regions of the world, locations within said regions, and different types and sizes of agricultural systems, such as large commercial or otherwise high-productivity farms, as well as small-scale agricultural systems operated by a single farmer, a family, or a number of operators in a range of 5 to 10 (hereafter referred to as “smallholder systems”).

For high-productivity farms, where large-scale plant cultivation may be carried out, the method of FIG. 1, and other exemplary methods and systems described herein, may provide a tool for pest monitoring and management. In addition, risk management platforms according to the present disclosure may be used by system operators, as well as agronomists, to identify pests, track their prevalence, and assess the extent of damage in different areas of an agricultural system. In turn, information provided by the methods and systems according to the present disclosure may: aid in making data-driven decisions regarding pest control measures, such as targeted pesticide application or implementing integrated pest management strategies; provide real-time updates and recommendations tailored to a specific region and thereby ensure pest threats are accurately identified; and enable rapid and effective responses to pest outbreaks to minimize potential plant losses and maintain consistent yields.

As applied to smallholder systems, exemplary methods and systems according to the present disclosure may offer several advantages to system operators, particularly those operators that may have limited access to resources, technical expertise, and information regarding pest management. Risk management platforms according to one or more aspects of the present disclosure may bridge resource, expertise, and/or information gaps by providing computer-implemented tools and interfaces that enable smallholder system operators to easily identify pests as early as possible, and understand risks associated with such pests. In some examples, risk management platforms may incorporate a software-based recommendation service that provides cost-effective and environmentally friendly pest control solutions suitable for smallholder systems. In some examples, these solutions may take into account financial constraints and available resources. In addition, exemplary recommendation services described herein may serve as educational tools and offer smallholder system operators valuable insights into: pest biology; prevention strategies; agricultural best practices; and increased opportunities to acquire knowledge that empowers these operators to enhance productivity and reduce plant losses.

Thus, exemplary agricultural risk management platforms according to the present disclosure may assist agricultural system operators (e.g., farmers) manage agricultural risks, specifically those risks that may be present in Theobroma cacao and agricultural systems designed to optimally grow, or otherwise purposed with growing, Theobroma cacao.

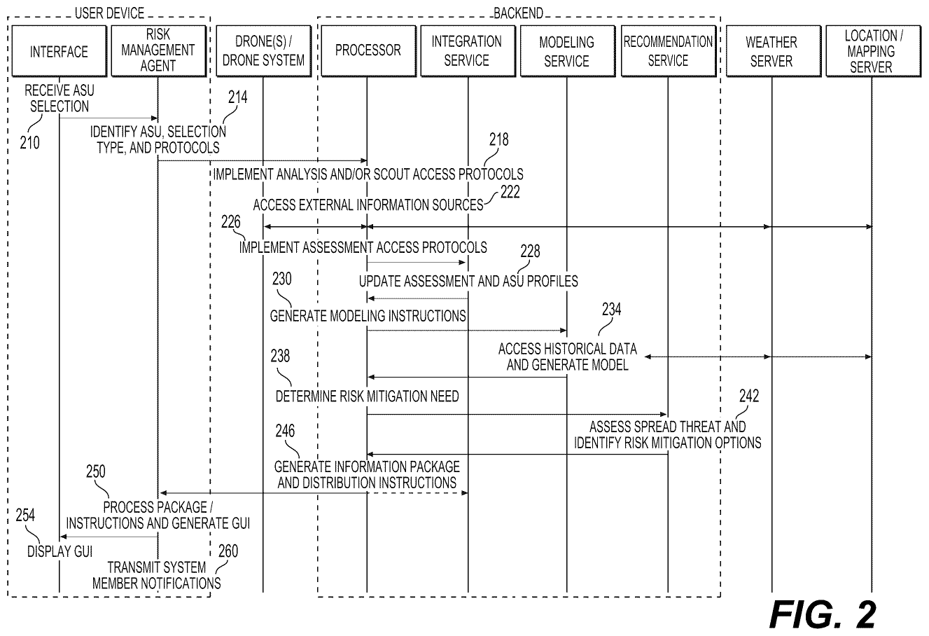

FIG. 2 depicts a sequence diagram of an exemplary method for managing risk in agricultural systems, according to one or more examples. At step 210, the exemplary method may include receiving an ASU selection through an interface of a user device. In one example, the ASU selection maybe be selected through a display including a list, a map, or other type of representation of ASUs for an agricultural system. In some examples, selection of an ASU may be received at step 210 at the interface from a test kit device, an image processing service, a drone operation service, a user, or through an API of another service implemented on or in communication with the user device of FIG. 2. A selection may be provided by a user, such as a system operator or other individual associated with an agricultural system, using various types of input/output (I/O) devices and/or services implemented through the user device that may be a computing device as defined herein. This may include a mouse, a touchscreen, a voice recognition service, and/or other biometric-related services.

In some examples, a selection of an ASU may be made in reference to an ASU that may have been tested with a test kit. Furthermore, the test kit may include a device that may include an interface and be configured to communicate with the user device such that an ASU selection received in step 210 is received from the text kit device.

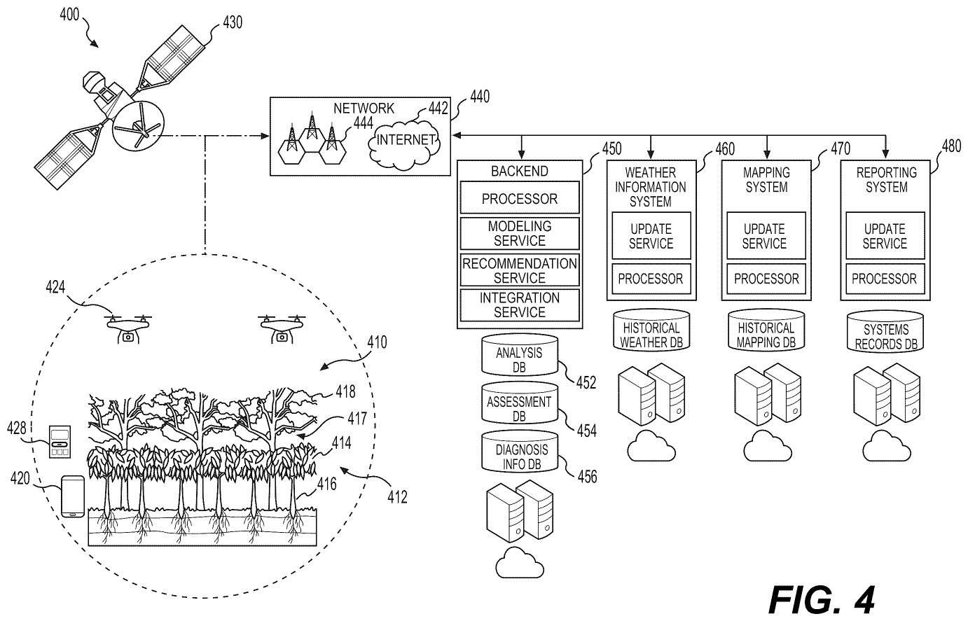

In step 214, a risk management agent implemented on the user device may identify an ASU selected, a type of ASU selection made, and any access protocols that may be associated with the selection type. In addition, at step 214, the risk management agent may cause transmission (e.g., by the user device) of data including the ASU selected, the type of ASU selection made, and access protocols, to a processor of the backend. In one example, the user device may transmit the data to the processor through a network or according to other communication protocols, such as those discussed in more detail with reference to FIG. 4. Similar type of data transmission may be employed by the processor or services of the backend in: accessing external information as part of, for example, step 222 discussed below; accessing mapping and historical weather information as part of, for example, step 242 discussed below; and transmitting an information package to the risk management agent as part of, for example, step 246 discussed below.

A selected ASU may be identified according to an identifier included in an instance of data generated or referenced as part of a selection process or type. In some examples, a selection type may be identified based on a source from which and/or method by which an ASU selection was received in step 210. In other examples, a selection type may correspond to an option displayed in a GUI being implemented through the interface of the user device. For example, a scout path option may be associated with an ASU, and selection of the scout path option in the context of the associated ASU may provide or otherwise define an identity and a type selection for that ASU. Access protocols may be identified by a risk assessment agent as may be permitted by a risk management platform backend. In other examples, data associated with access protocols may not be made available to a risk management agent being implemented on a certain devices (e.g., unauthorized or public devices) and/or through certain implementations of the risk management agent (e.g., implementation through a web application).

As previously noted, an exemplary risk management agent according to the present disclosure may be part of or configured to be compatible with a software product that is: installed on a computing device; provided through a web application executing in a browser running on a computing device; and/or implemented on a computing device through an application programming interface (“API”). With any of the implementations for a software product associated with an exemplary risk management agent mentioned above, the software product may be at least partially provided by a processor associated with a risk management platform implemented through a backend as shown in FIG. 2.

In some examples, the backend may include one or more computing devices, such as one or more servers, and each computing device for the platform may include a processor, a memory storage, and a non-transitory computer-readable medium containing instructions that are executed by the processor. In some examples, a backend for an example risk management platform according to the present disclosure may implement processes that: produce GPS rendered scouting maps; enable data collection at plant, block, sector, farm, and regional levels; employ statistical sampling methods and patterns for data collection; utilize GPS technology to guide system operators or designated data collectors (e.g., workers, drones) for an agricultural system through statistical scouting and/or sampling patterns; are configured to extrapolate data from summaries and geostatistics and create heat map visualizations from the extrapolated data; and/or assist with field diagnostics that may include performing image recognition of pathogens, insect pests, and abiotic symptoms (nutrient, fertilizer, water stressors).

At step 218, the exemplary method may include the backend implementing a plant analysis or ASU scouting access protocol. In one example, step 218 may be performed by a processor of the backend. Implementation of an access protocol may include retrieving, requesting, implementing a security procedure, and/or transmitting, generating, or allowing access to an analysis or scout path including a plant or plants corresponding to an ASU of an ASU selection received in step 210. In some examples, step 218 may include similar processes as step 120 of the exemplary method of FIG. 1.

In step 222, the backend, via the processor, for example, may access external information sources. This may include accessing a drone system, a server and/or other information source associated with a weather information system (“weather server”), and/or a server and/or other information source associated with a location and mapping system (“location/mapping server”). Weather information inputs to the backend from step 222 may relate to local, regional, and global weather events and conditions. In some examples, information from a drone system may be provided by drones that may survey an ASU once a selection of that ASU is received at step 210 (or step 110).

In some examples, an external information source may include one or more types of plant disease test kits. In particular, such test kits may be configured to determine whether a plant, for example a cocoa tree, is infected with an asymptomatic disease, such as CSSD. Exemplary test kits may be able to convey whether a cocoa tree is positive or not for CSSD and may employ, for example, a dip test or other type of test that avoid false positives or do not involve complex results or complex processes for reading results. In some examples, such a test kit may include a strip that can be viewed to see a positive or negative reading, or scanned with a device that indicates a positive or negative result to a user. In some examples, exemplary test kits that may be accessed by a backend or a risk management agent may include one or more devices configured to connect to a network or transfer data in some manner, via a phone, for example, to the backend that may further process test results in terms of plants, blocks, sectors, systems, and/or regions.

At step 226, the exemplary method may include the processor implementing one or more assessment access protocols. In step 228, an integration service may update assessments for an agricultural system as well as ASU profiles based on processes performed by, and communications with, the processor. In some examples, steps 226 and 228 may include similar processes as step 130 of the exemplary method of FIG. 1.

In addition, step 226 may include the processor for the backend performing image data processing and management, georectified farm image data processing and map creation, analytics of linked data types from various layers of data (e.g., levels of ASUS) input, visualization of data, generating data packages for implementing a decision dashboard through an interface provided by the backend and/or on the user device via the risk management agent, and combinations thereof. In other examples, assessment access protocols implemented at step 226 may incorporate drone flight data analytics processing and management, and/or drone stress monitoring using hyperspectral, thermal, and RGB sensors and other sensor types as needed for stress recognition. Furthermore, at step 228, the processor for the exemplary risk management platform backend may integrate drone data, such as drone flight protocol for stress monitoring and artificial intelligence (“AI”) analytics, and data from drone flight disease stress recognition technology.

With further reference to step 228, in one or more examples, an ASU profile may be updated with plant specific information that may correspond to information obtained from implementing the access protocols discussed above.

In some examples, a profile for an ASU, for example an agricultural system (e.g., a farm), may include information or values for the agricultural system corresponding to parameters or attributes including, but not limited to: location; agricultural system size; age; plant type (e.g., cocoa); plant species type (e.g. hybrid cocoa); number of co-planted plants; number of high yielding plants; average monthly/yearly yield (e.g., cocoa produced per hectare (in kg)); pest or insects previously identified as present with the agricultural system; number of healthy plants per scouting event and per season; system maintenance practices (y/n questions on best practices); fermentation process; degrees of compliance with harvest and/or post-harvest best practices; proximity to neighboring agricultural systems; average monthly/yearly rainfall; average monthly/yearly temperature; average monthly/yearly humidity; type of agricultural system; % of plants shaded; % of plants in full sun; planting density; harvesting method; and other parameters.

In other examples, a profile for an ASU, for example a plant (e.g., a cocoa tree), may include information or values for the plant corresponding to parameters or attributes including, but not limited to: genus; species (scientific); canopy cover; plant size (e.g., height, diameter, diameter at breast height); number of plant parts for yield; number of damaged leaves; number of damaged non-leaf plant parts; presence of insects or pests; fertilizer used; branch count; proximity to co-farmed plants; location in an agricultural system; resistance trait; history of disease in nursery lot; history of pest and disease in field/block; age; current disease status; type of ASU including the plant (e.g., uniform area-unit, non-uniform area-unit); type of agricultural system including the plant (e.g., agroforestry); and other parameters or attributes.

As shown, the backend may implement the integration service, as well as an integration service and a recommendation service, one or more of which may provide a software product that may be at least partially provided by the processor of the backend or other computing device associated with the risk management platform implemented through the backend. Accordingly, one or more of the integration, modeling, and recommendation services may be configured to instantiate, update, maintain, or otherwise support aspects of the risk management platform, risk management agent, or portions/modules thereof.

At step 230, the exemplary method of FIG. 2 may include generating, at the processor, modeling instructions. In one example, the modeling instructions may include analysis, scouting, assessment, and/or externally-obtained information from any of the preceding steps described above. In another example, the modeling instructions may include information input as part of the ASU selection received in step 210. For example, ASU selection may include a request for a model that specifies an ASU and time period for the model.

In step 234, a modeling service implemented by the backend may access historical data pertaining to the agricultural system corresponding to the ASU selected in step 210 and generate a model for a selected ASU and/or ASUs including the selected ASU. In some examples, the modeling service may perform machine learning predictive management, and provide machine learning predictive analytics. In other examples, the modeling service may be configured to perform yield, disease, and/or loss forecasting with respect to a selected ASU and/or ASUs (e.g., an entire agricultural system) including the selected ASU. The modeling service may utilize, generate, or otherwise implement stochastic and mechanistic predictive models and combinations thereof with respect to forecasting. In addition, step 234 may include utilizing, generating, or otherwise implementing metadata machine learning analytics, sensor inputs from various sources linked in time and space, and historical data analysis for predictive management.

At step 238, the exemplary method may include the processer determining a need for risk mitigation measures and implementing a recommendation service based on the determined need. In some examples, step 238 may include processes, inputs, and outputs similar to those of step 140 of the exemplary method of FIG. 1. At step 242, the recommendation service may assess a threat of spread and identify one or more risk mitigations options.

In some examples, this may include notifying a user of, and providing access to, one or more guides selected from one or more groups of guides related to integrated pest management best practices. Such guides may be selected by the recommendation service and/or processor based on analyses, assessments, and/or external information from other steps such as steps 218, 222, and 226. Furthermore, the recommendation service may provide access to decision tools which may direct an operator to one or more guides. Still further, the recommendation service may process any of the information accessed, received, or generated in any of the preceding steps of the exemplary method of FIG. 2, and identify virtual and other types of training guides in various media formats that relate to: plant disease, insects, abiotic symptoms; insect and disease scientific knowledge; and combinations thereof. In other examples, at step 242, based on the risk mitigation need determined in step 238, the recommendation service may identify, suggest, provide access to, and/or obtain information related to: sampling techniques for pathogens and insects; diagnostics help features; diagnostics identification and sampling instructions; accessing and using diagnostics professional networks; and/or locating and/or providing directions to local diagnostics labs; and combinations thereof.

At step 246, the exemplary method may include generating an information package and information distribution instructions at the processor of the backend based on a combination of data associated with the processes executed, performed, or otherwise completed in steps 218 to 242. Such an instruction package may include instructions that when executed, for example by a processor of a user device under the direction of the risk management agent at step 250, may result in one or more GUIs being displayed on the user device. In addition, the instructions at step 246 may include instructions, communication protocols, and the like for disseminating information related to analyses, assessments, models, and/or risk mitigation techniques of the previous steps. Such instructions may specify a distribution list of individuals and/or organizations for receiving the information. This may include other workers or operators for an agricultural system; governing bodies associated with a plant corresponding to an ASU selection at step 210; operators of other agricultural systems that may be located near or within a general area including an agricultural system including the ASU selected in step 210; and other relevant individuals or organizations.

In step 250, the risk management agent may process to the information package and distribution instructions and generate a graphical user interface based thereon. At step 254, the exemplary method may include the interface displaying the GUI generated in step 250. In some examples, the information package received at step 250 may include dissemination instructions which the risk management agent executes in step 260. Thus, at step 260, depending on how the risk management agent may be implemented on the user device (e.g., as a dedicated application, a web application, API, via a cloud based service, etc.), the risk management agent may transmit, request permission to transmit, or request transmittance of notifications to individuals and/or organizations associated with an agricultural system, or group of agricultural systems, or region including the ASU specified in the ASU selection at step 210.

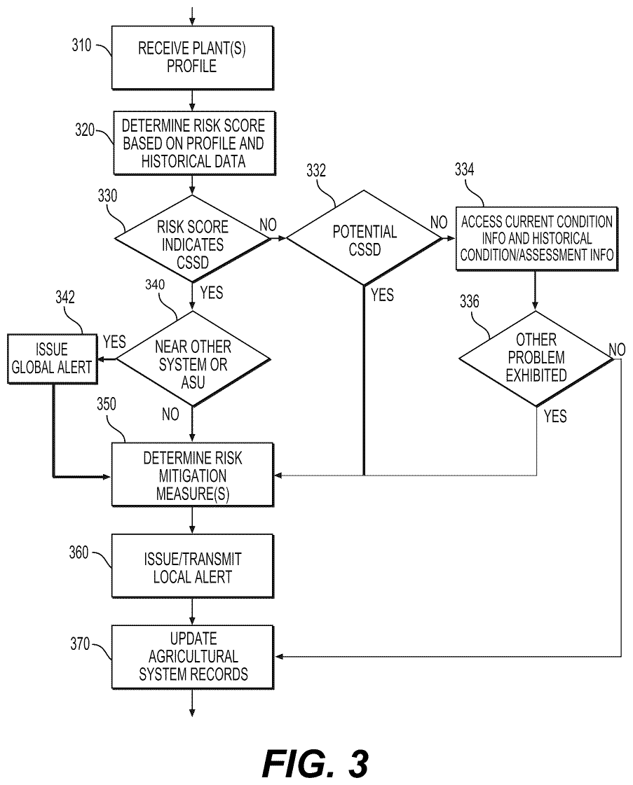

FIG. 3 depicts a flowchart of an exemplary method for identifying agricultural risk mitigation techniques, according to one or more examples. In some examples, the method of FIG. 3 may be specifically applicable to cocoa trees and agricultural systems including cocoa trees. At step 310, a profile for at least one plant may be received. At step 320, the exemplary method may include determining a risk score based on information included in the profile, additional historical data, and/or any analysis or assessment information related to the plant that may reference in the profile or accessible as a result of indexing processes that may be implemented by an exemplary risk management platform according to the present disclosure. In one example, an assessment for a single plant may include a diagnosis or identification of damaged leaves and/or an indication of a presence of one or more insects.

At step 330, the exemplary method may include determining if the risk score indicates a plant is diseased. In implementations specific to agricultural systems including cocoa trees, as shown, step 330 may be specific to a determination of whether or not a plant or plants exhibit CSSD. In some examples, the risk score determined in step 320 may be compared to a threshold score in step 330. Where the risk score is greater than a threshold, at step 340, a plant or plants, or an ASU including the plant or plants, may be evaluated for a respective proximity to another ASU (e.g., another block or sector), and/or an another agricultural system. In instances where the ASU evaluated is within a minimum distance of another ASU or agricultural system, a risk management platform implementing the exemplary method of FIG. 3 may issue a global alert at step 342. In some examples, global may refer to all operators and other workers for an agricultural system. In other examples, global may refer to a region that includes the agricultural system that includes the plant or plants from step 310, and other agricultural systems located in that region.

If the risk score does not exceed the threshold score, a risk management platform may compare the risk score to a lower threshold in step 332, in some examples. The lower threshold may be indicative of a combination conditions for other plants that did not exhibit CSSD when those conditions were observed, but later did exhibit CSSD. Such conditions may or may not be recognized as symptoms of CSSD according to some aspects. Rather, it may be the case that such conditions may be comorbid for plants that eventually exhibit CSSD. In other examples, a profile for the plant or plants may be checked in step 332 (again) for any parameter values and/or attributes that in isolation, have been associated on some level, with plants eventually exhibiting CSSD. At step 334, current condition information and historical condition and assessment information may be accessed, and a determination of whether or not a plant or plants are exhibiting another problematic condition that may not be associated in with CSSD.

Once a global alert is issued in step 342, a determination is made in step 340 that an ASU is not near another ASU, a determination is made that a plant or plants have the potential to be diseased with CSSD at step 332, or another problem is identified in step 336, a risk management platform may identify risk mitigation techniques in step 350. In some examples, one or more processes performed in step 350 may be similar to those in steps 238 and/or step 242 of the exemplary method of FIG. 2.

At step 360, the exemplary method may include a risk management platform and/or risk management agent issuing and/or transmitting a local alert. In some examples, the local alert may be transmitted to the computing devices associated with all workers and operators for an agricultural system including a plant or plants from step 310. In other examples, the alert may be transmitted to a select group of individuals associated with the agricultural system. In some examples, the alert may specify a problem or disease identified, a list of individuals receiving the alert, a risk mitigation technique identified, a proximity between ASUs, and/or an indication of urgency.

At step 370, records for an agricultural system including a plant or plants from step 310 may be updated. In some examples, this may include updating assessments and respective profiles associated with one or more ASUs that include the plant or plants. In addition, step 370 may include similar processes as step 228 of the exemplary method of FIG. 2.

FIG. 4 depicts exemplary system components for managing risks in agricultural systems, according to one or more examples. The exemplary system components illustrated in FIG. 4 may provide or otherwise define an example risk management platform configured to assist in the collection and/or act as a repository for collecting plant level, area-unit level, sector level, agricultural system level, and regional level data from field, farm, greenhouse, and nursery settings. In some examples, the exemplary system components may monitor and operate based on the conditions observed in an exemplary agricultural system 410 as shown. Such an agricultural system may include plants 412 (e.g., cocoa trees) that include identifiable plant parts such as leaves 414 and non-leaf parts 416 (e.g., pods) that may be monitored for diseases, insects, pests, and/or levels of pesticide exposure. In some examples, the agricultural system 410 may be an agroforestry agricultural system in which plants 414 grow under non-cultivated plants 418 (e.g., large trees) that may provide shade to plants 412 non-uniformly across an area that defines the agricultural system 410.

Data collected may include pest and disease data for various plants (e.g., cocoa trees) and plant parts (e.g., organs, leaves, pods, tissues) that may be affected by species of: (a) fungal, bacterial, viral, and other pathogens; (b) species of insects and mites; and/or (c) abiotic symptoms (nutrient, fertilizer, water stressors).

The system components 400 can include a backend 450, one or more user devices 420, one or more computing devices dedicated to data collection, such as drones 424 and test kits 428, and various additional sources of (external information). In some examples, the additional sources of information may include devices such as satellites 430, and/or servers or computing systems that provide or otherwise define information systems. As shown, such information systems may include a weather information system 460, a mapping system 470, and a reporting system 480. System components and information systems may be in communication through a diversified network 440 that includes different sub-networks such as the internet 442 and one or more cellular networks 444. In addition, user devices 420, drones 424, and test kits 428 can be in direct communications with each other via wireless communication protocols (e.g., Bluetooth, Bluetooth Low Energy, Zigbee, or a Wifi chip—this option may allow for direct communication with, for example, a cloud).

In one example, the backend 450 can include one or more physical servers, and or cloud-based virtual servers that support services and agents operating on other system components. In addition, the backend 450 can be provided with software-based tools through which an administrator can monitor, manage, update, and modify aspects of, for example, a risk management agent being implemented on one or more user devices 420. Furthermore, the backend may support the operations of services and agents (e.g. software applications) being implemented on various devices. Such devices, which may or may not include the user device 420, may be managed devices that the backend 450 has direct control over. Regardless of a level of control the backend 450 may have, each of the services and/or agents running or otherwise being implemented on the backend 450, user devices 420, drones 424, and test kits 428 may be part of, or configured to be compatible with, a software product that is at least partially provided by the backend 450.

The backend 450 may be supported by analysis, assessment, and diagnosis repositories 452, 454, 456. According to an aspect of the present disclosure, each of these repositories can be a database that is hosted on one or more servers. In another example, one or more of the repositories can be a cloud-based storage component that is part of an infrastructure that includes various computing devices (e.g., user devices and wearable devices) and cloud-based services interconnected by local networks, wide-area networks, wireless communications, and the Internet.

Additional features of systems and methods described herein, including a recommendation service implemented on the backend 450, for example, may include: receiving insecticide inputs and monitoring for resistance program alignment; providing pesticide compliance guidance and monitoring; providing biological control compliance guidance and beneficials monitoring; and combinations thereof. In some examples, a risk management platform provided by the backend 450, and/or a risk management agent implemented on the user device 420, for example, may employ point cloud data storage, in network and out of network data upload and processing capabilities, and API to agricultural system management software, and combinations thereof.

Systems and methods described herein may assist in early detection and monitoring of pests in agricultural systems. Operators (e.g., farmers) and agricultural experts may use a risk management agent implemented by a risk management platform through a computing device to quickly identify unfamiliar insects and report their presence. Exemplary risk management platforms may facilitate timely sharing of information and enable implementation of appropriate measures to prevent establishment and spread of invasive pests. In addition, a risk management agent implemented by a risk management platform through a computing device can provide information on potential risks associated with pests, including respective behaviors, preferred habitats, and crops these pests are known to infest. In turn, operators may be equipped with knowledge needed to take preventive actions, implement biosecurity measures, and effectively manage potential pest incursions. Ultimately, systems and methods described herein may contribute to sustainable plant (e.g., cocoa) production by minimizing pest damage and promoting efficient pest management practices.

FIG. 5 depicts an illustration of an exemplary graphical user interface (“GUI”) used to implement various methods described herein. More specifically FIG. 5 provides an illustration of an exemplary GUI 500 that presents a home page 510 and a menu/navigation bar 580 for selecting different modules that may be provided by a risk management platform through a risk management agent implemented on a user device 502. In one example, individual ASUs for an agricultural system may be selected from any of the modules described herein. The combination of a specified ASU selected within a particular module may define a selection type for the purposes of aspects (e.g., step 120, step 214) of exemplary methods described herein.

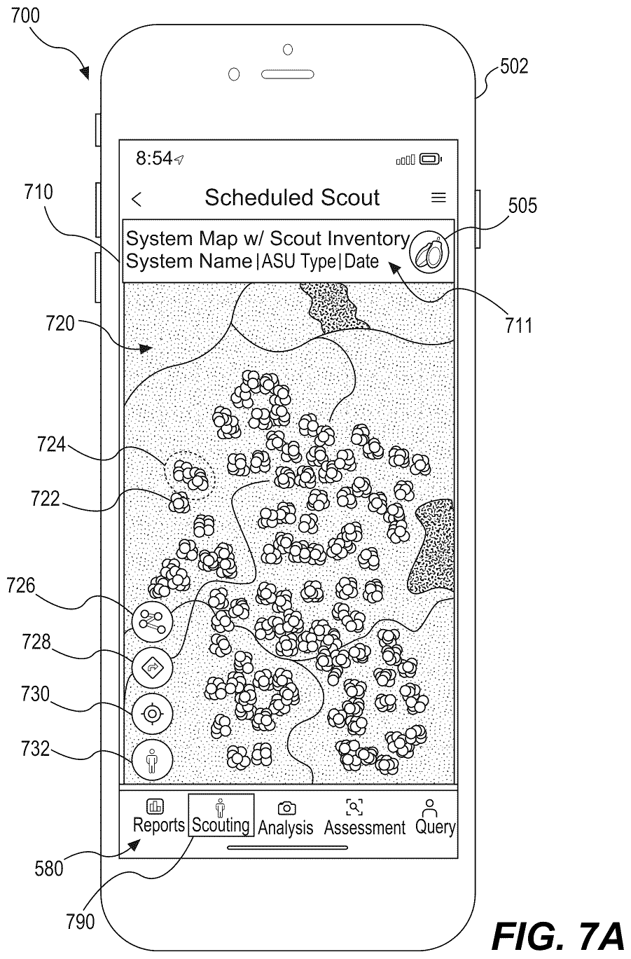

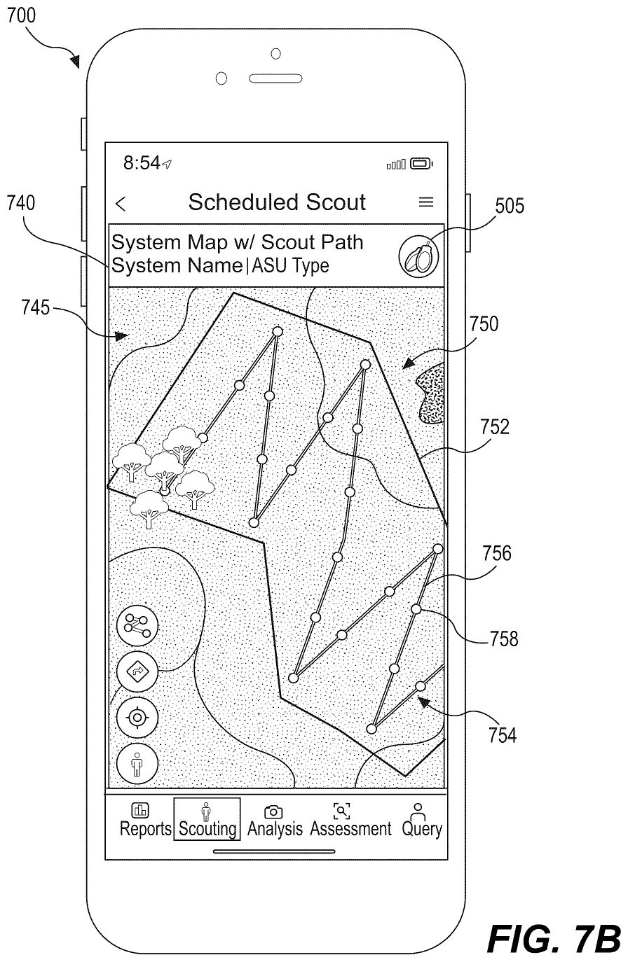

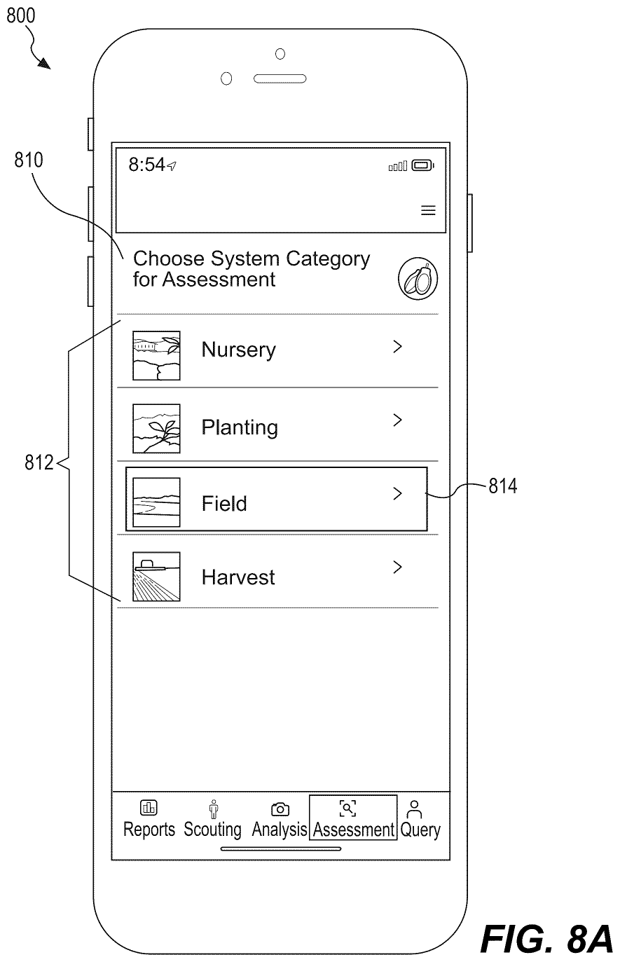

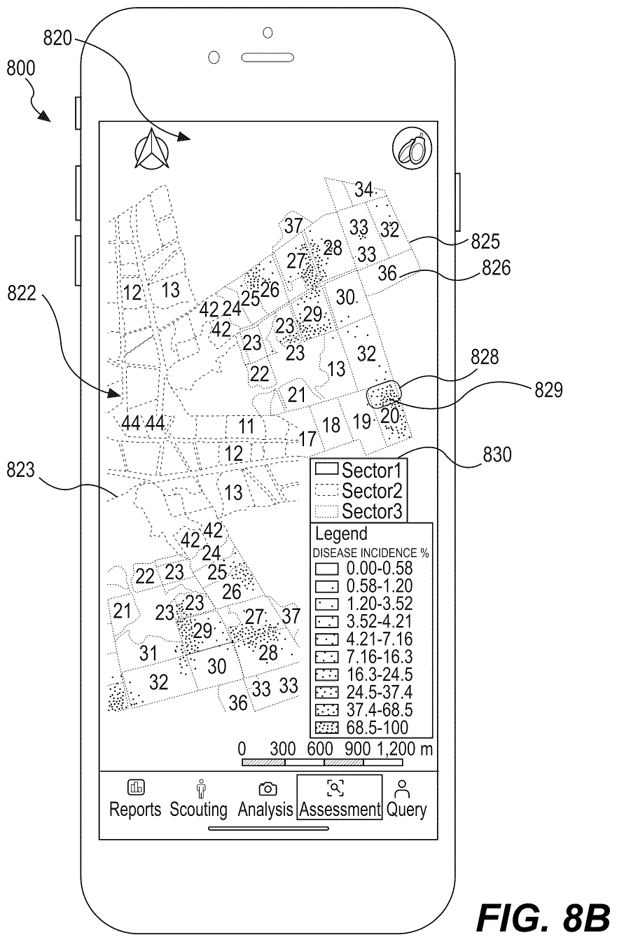

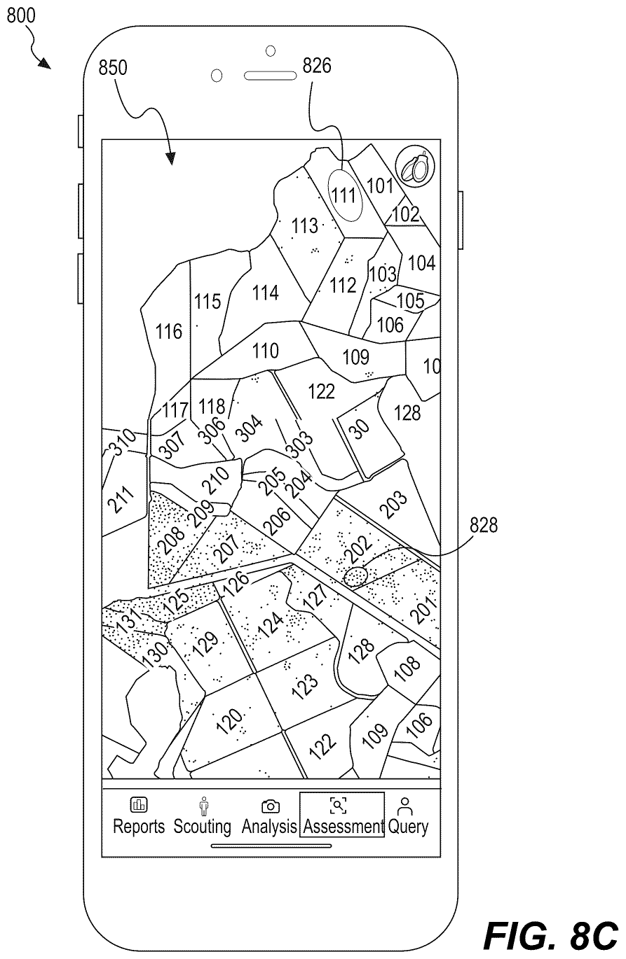

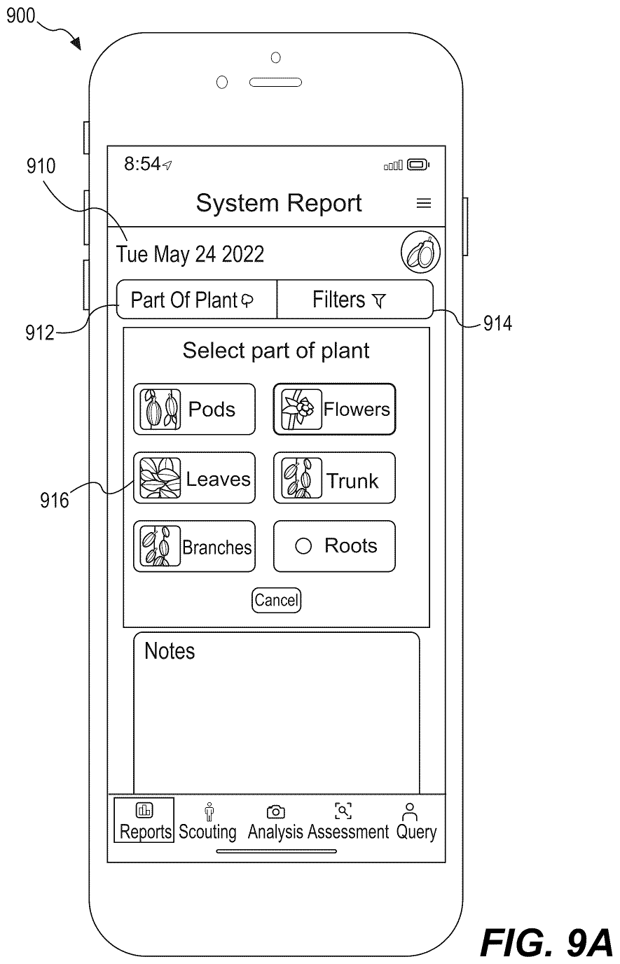

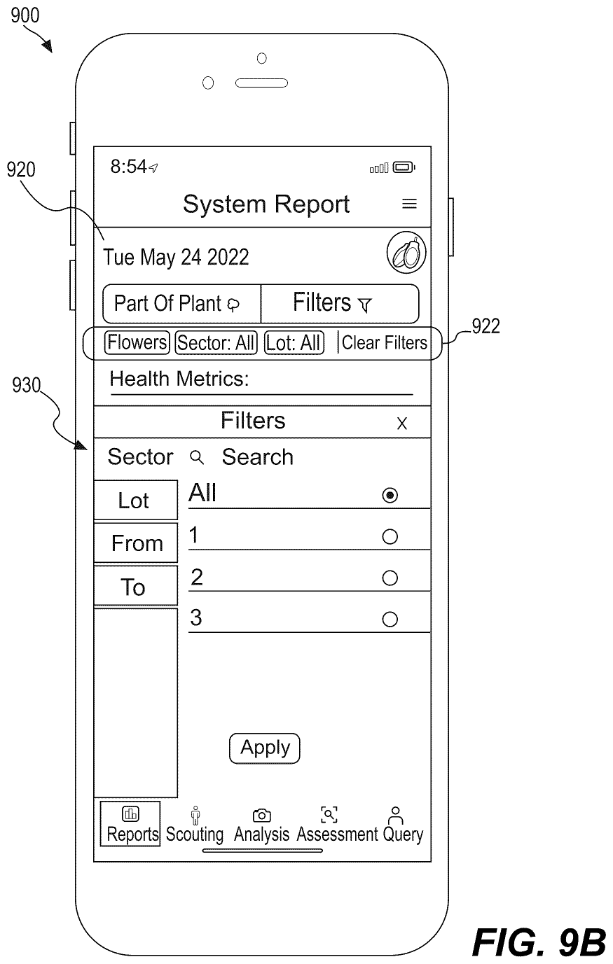

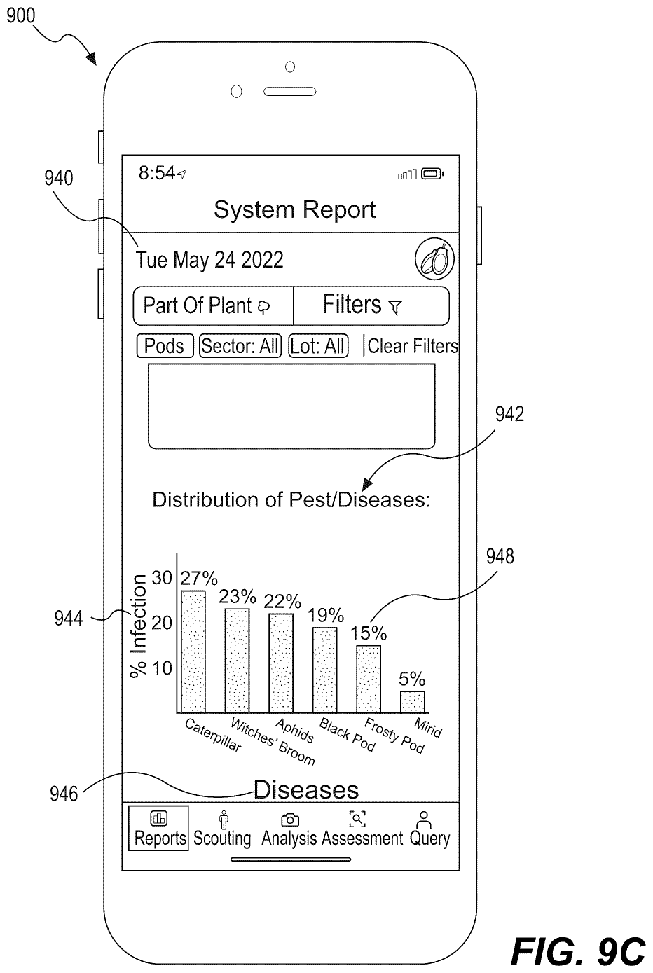

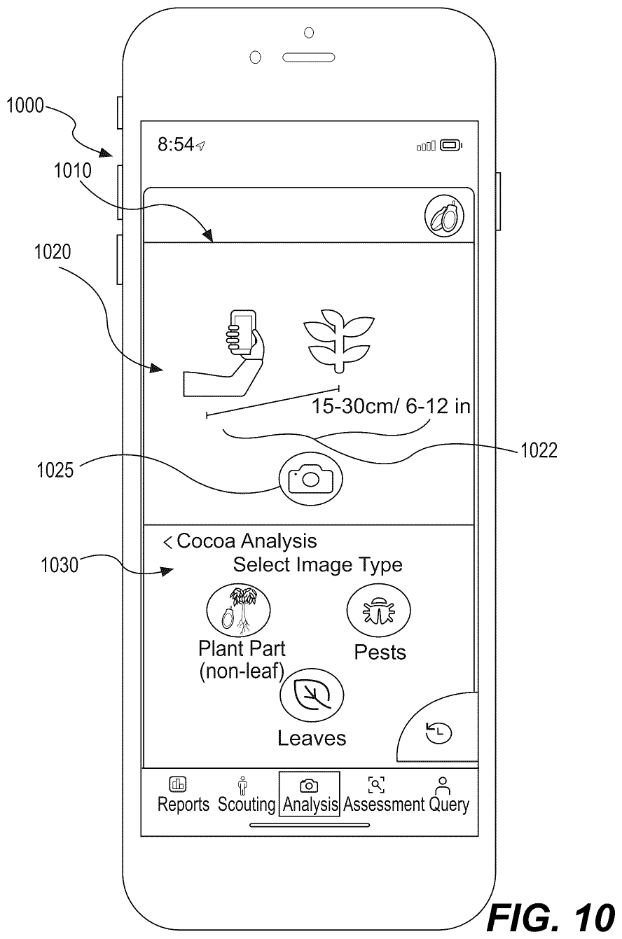

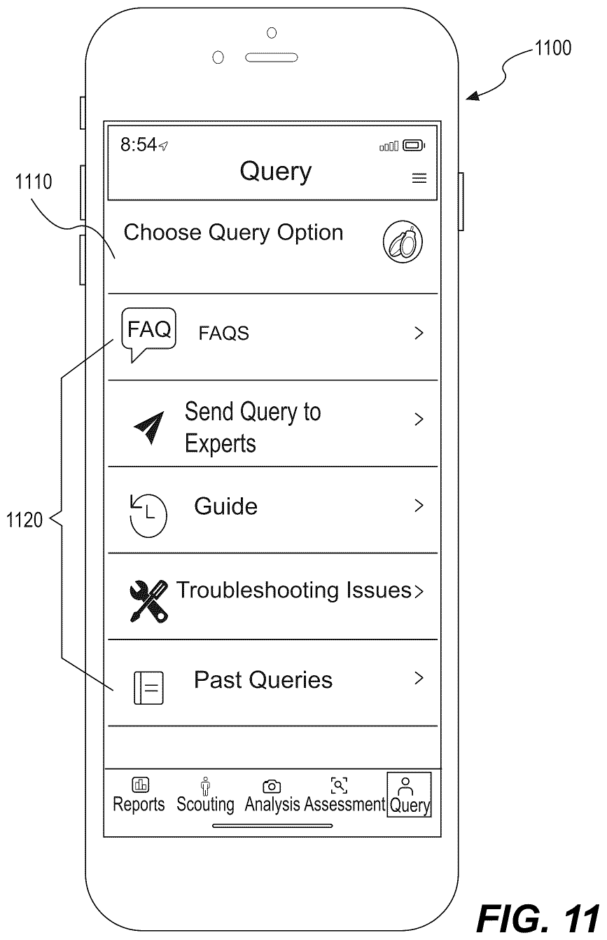

In one example, the home page 510 may provide: a system profile option 505 for accessing profile module 600 described in more detail with reference to FIGS. 6A-6C; a reports option 520 for accessing a reporting module 900 described in more detail with reference to FIGS. 9A-9C; a scout plan option 530 for accessing a scouting module 700 described in more detail with reference to FIGS. 7A and 7B; a diagnostics/assessments option 540 for accessing an assessment module 800 described in more detail with reference to FIGS. 8A-8C; an analysis option 550 for accessing an analysis module 1000 described in more detail with reference to FIG. 10; a guide option 560 for accessing guides and recommendations that may include content provided through an example recommendations service, such as a recommendation service of the method of FIG. 2; and a query option 570 for accessing a query module 1100 described in more detail with reference to FIG. 11. In addition to the options described above, the menu/navigation bar 580 may include report, scouting, analysis, assessment, and query selection options 582, 584, 586, 588, 589 for accessing corresponding modules.

FIGS. 6A and 6B depict illustrations of exemplary GUIs of profile module 600 for defining an agricultural system, according to one or more examples. In particular, FIG. 6A illustrates a system profile GUI 610 that includes, in one example, a table of system attributes and parameters 614 (“system table 614”) for defining a profile for an agricultural system associated with, for example, login credentials that may have been entered through the user device 502 to access the GUI 500 of FIG. 5. On the other hand, FIG. 6B illustrates a plant profile GUI 630 that includes, in one example, a table of plant attributes and parameters 634 (“plant table 634”) for defining a profile for a plant included in the agricultural system of the system profile GUI 610, in one example. Attributes and parameters included in the system and plant tables 614, 634 may depend on a system type (e.g., agroforestry, row plant, small, large, commercial), location, and other factors associated with an agricultural system corresponding to the system and profile GUIs 610, 630.

Both the system table 614 and the plant table 634 may provide data entry options including free form options 616, non-binary drop-down options 617, binary drop-down options 619, and formatted entry options 618 that may be selected by an operator or worker to enter information regarding an agricultural system. In some examples, the non-binary drop-down options 617, when selected, may cause a list of selectable parameter or attribute values (e.g., 100/200/300 acres, plant/block/sector ASU) to be displayed. On the other hand, the binary drop-down options 619, when selected, may cause a list of two selectable options (e.g., Yes/No, Y/N, 1/0) to be displayed.

In addition to the tables described above, the system and plant profile GUIs 610, 630 may include a notes data entry field 624, a save option 626 for saving entered information, a clear option 628 for clearing entered information, and a more option 629 that may be selected to view additional attributes and parameters. In addition, the system and plant profile GUIs 610, 630 may include the menu/navigation bar 580 allowing a user to navigate to other modules. Still further, the system and plant profile GUIs 610, 630 may include a profile summary option 605 for accessing a profile summary GUI 640 illustrated in FIG. 6C.

FIG. 6C depicts an illustration of an exemplary profile summary GUI 640 profile module 600 for summarizing a profile of an agricultural system, according to one or more examples. As illustrated, the profile summary GUI 640 may include a system identification section 650, a statistical assessment section 660, a mapping assessment section 670, and a weather information section 680. Information included in the system identification section 650 may include name, location, and size information. In other examples, the system identification section 650 may include operator identification and number information and worker number information. As illustrated in FIG. 6C, the weather information section 680 may include current and forecasted weather conditions for an area including an agricultural system associated with the information provided in the profile summary GUI 640.

The statistical assessment section 660 may include a date entry field 662, a plant statistical summary 664, and a plant part statistical summary 668. As illustrated, the statistical summaries may provide percentages of plants and plant parts found to be infected. The mapping assessment section 670 may include a map type menu 672 and a map 674 in one example. The map 674 may include a legend 678. In one example, the map 674 illustrated may include a heat map or a dot density map, that the legend 678 may inform a user of what type of plant/ASU information is associated with different gradients (of color or dot densities) that are presented on the map 674 to reflect, as examples: areas within an agricultural system and volumes of plants or other ASU types within those areas exhibiting some condition, such as a disease (e.g., CSSD); presence of pests; different levels of vegetation; and other aspects of an agricultural system (e.g., other parameters or attributes that may be tracked).

Information included in all the illustrated sections may correspond to a date or date range entered into the date entry field 662. In the case of a range, information provided in the illustrated section may be provided in terms of averages. For example, the system identification section 650 may show an average number of workers that worked in the agricultural system over a range of dates specified in the date entry field 662. In a similar manner, averages for a number of plants, a number of plant parts, dot density over time, and daily historical precipitation percentage may be displayed for when a date range is specified.

FIGS. 7A and 7B depict illustrations of exemplary GUIs of scouting module 700 for assisting operators and workers monitor an agricultural system, according to one or more examples. In particular, FIG. 7A illustrates a scouting inventory GUI 710 that includes, in one example, an ASU identification section 711 and an ASU inventory map section 720. The menu bar 580 may also be displayed along with a module identifier 790 indicating the module currently being displayed. The ASU inventory map section 720 may include ASU illustrations 722 of plants or other types of ASUs include in an ASU identified in the ASU identification section 711. As illustrated, the plants or other types of ASUs 722 may be illustrated in clusters 724, and thereby reflect a relative volume of plants or other types of ASUs in an actual area of an agricultural system corresponding to location a within the map section 720 in which the cluster 724 is illustrated.

In some examples, a cluster 724 or a single ASU 722 may be selected or hovered over to obtain more information regarding that ASU, or to identify an ASU for which a user may want to view a respective scout path for by subsequently selecting a path option 726 included in the scouting module 700. As a result, scouting module 700 may provide a scouting path GUI 740, as illustrated in FIG. 7B. The scouting path GUI 740 may include a scout path map section 745 in which path information 750 for an ASU selected from the scouting inventory GUI 710, or otherwise identified in the ASU identification section 711, is displayed. In another example, an ASU or ASU cluster within the inventory map section 720 may not be selected when the path option 726 is selected. In these instances, the scouting module 700 may display path information for an inventory of ASUs displayed in the scouting inventory GUI 710.

The path information 750 may include an illustration of a boundary 752 of an ASU and a scout path 754 within the boundary 752 of the ASU. The scout path 754 may include route sections 756 extending between nodes 758. In some examples, the nodes 758 may represent plants or other types of ASUs for which an analysis is to be conducted. In another example, ASUs for analysis may be distributed along the route sections 756 between the nodes 758. In this example, the nodes 758 may correspond to locations where analysis information should be transmitted in some manner to another individual or component of a risk management platform. In other examples, the nodes 758, depending on the area covered by the scout path 754, may correspond to stopping points. Selection of one the nodes 758 in this example may result in a display of a date by which a scouting activity including the node 758 and/or duration of time required to complete that scouting activity.

In addition to the path option 726, both of the scouting inventory GUI 710 and the scouting path GUI 740 may include various types of navigation and view options that may be selected. In particular, a direction option 728, current location option 730, and alternative view option 732 may be provided. In some examples, an ASU 722 or ASU cluster 724 may be selected, followed by a selection of direction option 728. In some examples, this series of selections may cause a risk management agent implementing the scouting module 700 to access location information for the user device 502 and the selected ASU/cluster, and generate directions there between that may be displayed in the scouting path GUI 740. In some examples, a satellite, such as satellite 430, and/or a mapping system, such as mapping system 470, may be accessed in order to generate the directions.

Functionality similar to that of the direction option 728 may be provided with the alternate view option 732. That is, where an ASU is not selected, selection of the alternate view option 732 may result in the risk management agent accessing location information for the user device 502. A “street view” of the ASU identified from in ASU identification section 711 may then be provided from a perspective of the obtained location for the user device 502. In other examples, where an ASU within the ASU inventory map section 720 is selected prior to selection of the alternate view option 732, a view (e.g., “street view”) of the selected ASU may be presented by the scouting module 700.

FIG. 8A depicts an illustration of an exemplary assessment menu GUI 810 for an assessment module 800 for selecting a type of assessment, according to one or more examples. As shown, the assessment menu GUI 810 may include several selectable level options 812 corresponding to a portion of an agricultural system, such as a nursery or a field, and types of activities, such as planting and harvesting, that may be performed at the agricultural system. In one example, selection of a field option 812 may cause the assessment module 800 to display a first ASU assessment GUI 820 illustrated in FIG. 8B.

As shown in FIG. 8B, the first ASU assessment GUI 820 may include a plot (map) of ASUs of an agricultural system 822. In particular the first ASU assessment GUI 820 illustrates at least three ASU levels including a sector level with sector ASUs 823, an area-unit level with area-unit ASUs 825, and a plant level with plant ASUs 829. Additional information may include ASU identifiers 826 and density indicators 828 that may convey scale of the occurrence of a condition (e.g., CSSD) for one level of ASUs (e.g., plant level) within the higher level ASU (e.g. area-unit level).

In other examples, the density indicator 828 may convey a scale of a population of one level of ASUs (e.g., plant level), within a higher level ASU (e.g., a block). In still other examples, one or more ASU level indicators included the ASU assessment GUI 820, such as the sector ASUs 823, area-unit ASUs 825, and plant level 829 ASUs, may be presented in different manners to also represent density indicators of some aspect of the agricultural system 822 and/or a respective ASU level. For example, in some examples the density indicator 828 (i.e., packing together of plants) may convey a scale of a population of plants (plant ASUs 829) within a respective area-unit (area-unit ASUs 825). In addition, each plant ASU 825 may be presented in such a manner (e.g., a color, shape, pattern within a shape) that reflects a respective condition (e.g., type of plant, disease status (generally), type of disease such as CSSD, yield, age, insect/pest presence, etc.) of that plant.

In some examples, an ASU displayed the first ASU assessment GUI 820 may be selected (an ASU selection), and the assessment module 800 may generate a second ASU assessment GUI 850 with respect to the selected ASU as illustrated in FIG. 8C. In one example, the second ASU assessment GUI 850 may represent a selection of a Sector 1 sector ASU 823 as shown in a legend 830 of the first ASU assessment GUI 820.

In the exemplary first and second ASU assessment GUIs 820, 850 of FIGS. 8B and 8C, each area-unit ASU 825 (area-unit shape) may represent a hectare of the agricultural system 822 (e.g., a farm). The agricultural system 822 illustrated in FIG. 8B may represent, in one example, a cocoa tree farm. Accordingly, the area-unit ASUs 825 are non-uniformly shaped because the agricultural system 822 is an agroforestry agricultural system. In one example, the plant ASUs 829 that resemble dots in FIG. 8B may provide a mapping out of the presence of Phytophthora (which causes black pod) and other types of fungi that may cause problems in cocoa trees. Furthermore the density indicator 828 may represent that multiple types of fungi are present where the plant ASUs 829 are closely clustered.

In some examples, risk management platforms according the present disclosure may provide the first or second ASU assessment GUIs 820, 850 in a form that includes multiple versions respectively thereof for different dates or date ranges overlaid on another. In this example, an ASU assessment GUI displayed may represent a mapping of agricultural system 822 over time which also includes mappings of the presence of fungi in agricultural system 822 (and ASUs 823, 825, 829 thereof) over time. As such, the displayed ASU assessment GUI may highlight/identify a combination of factors (e.g., weather) that once recognized may be used to predict what may happen at other times where the same or similar combination factors persist.

For example, such a time-reflective ASU assessment GUI may provide information that every May, it is rainy and warm in a northern part of the agricultural system 822. Furthermore, the ASU assessment GUI may reflect that during this period, the northern part the agricultural system 822: (1) exhibits increased levels of types of fungi and/or increased level of a particular type of fungus (e.g., Phytophthora); and (2) more black pod is present during this time of year in the trees within this area of the agricultural system 822 than other times of the year. An exemplary risk management platform, in addition to causing this assessment to be displayed in the assessment module 800 on the user device 502, may employ a service, such as the modeling service of FIG. 2, to process the data used to generate the displayed assessment. In turn, the risk management platform may access (determine, estimate, calculate) a prediction that another area of the agricultural system 822, has similar characteristics as the northern part, may see increased levels of black pod in November when conditions (rainy and warm) are the same or similar as the conditions for the northern part in May.

As discussed above, exemplary risk management platforms according to the present disclosure may link weather data, agricultural system layout data, and mapped ASU condition information and utilize this combination of data to predict what a potential epidemic outbreak may look like during some time in the future. Based on this information, system operators may, for example, make adjustments to a water system to reduce or increase supply and/or increase a frequency by which plants are analyzed and assessed. In some agricultural systems, monitoring procedures (e.g., performing a scouting activity) may require an individual to physically walk hectares and hectares of land to look at plants using, for example, computing devices described herein. It is likely that it is not feasible to perform this type of monitoring every day or even every week. Accordingly, aspects of the present disclosure may be directed toward a risk management platform that configures monitoring plans based on assessments generated thereby and from which the risk management platform determines critical periods within plant growing cycles when monitoring should be increased. In addition, exemplary risk management platforms according to the present disclosure may be configured to automatically update such monitoring plans based on weather predictions, seasonality, and yield predictions with the passage of time and continued operations of an agricultural system such as a cocoa tree farm.

FIGS. 9A and 9B depict illustrations of exemplary GUIs for a reporting module 900 for selecting a type of agricultural system report, according to one or more examples. As illustrated in FIG. 9A, the reporting module 900 may include a plant focus setup GUI 910 accessible via a plant part selection option 912. The plant focus setup GUI 910 may include plant part selection options 916 to specify a focus of a report to be generated. In addition, a filter selection option 914 may also be included in the plant focus setup GUI 910 and selection thereof may cause the reporting module 900 to display a filter setup GUI 920 as illustrated in FIG. 9B.

The filter setup GUI 920 may include a filter summary section 922 showing filters already selected for a report to be generated. In addition, a search section 930 may allow a user to select a date or date range and identify an ASU, a group of ASUs, or a group of ASUs within a higher level ASU, to include in the report. An exemplary report 942 is illustrated in FIG. 9C as part of an exemplary report GUI 940. As shown, the report 942 provides a comparison between types of diseases 946 according to a percentage of plant parts 944 (e.g., pods) within an ASU specified in the search criteria section 930 (see FIG. 9B) infected by one or more of the respective diseases.

The report 942 illustrated in FIG. 9C is one type of report that risk management platforms and agents described herein may generate. One of ordinary skill in the art will readily appreciate reports with different parameters and focuses may be provided with the systems and methods described herein.

FIG. 10 depicts an illustration of an exemplary analysis GUI 1010 for an analysis module 1000 for analyzing ASUs, according to one or more examples. In some examples, selecting and requesting or actuating a type of analysis may be functionalities provided by the analysis GUI 1010. As shown analysis GUI 1010 include a guide section that may include instructions 1022 for using a device to analyze an ASU (e.g., one or more plants) according to the present disclosure. An activation option 1025 may be selected to initiate an image capture of a subject to be analyzed. In one example, the analysis GUI 1010 may include a subject identification section 1030 for inputting a type of subject that will be included in an image that is about to be captured, or is in a previously captured image.

FIG. 11 depicts an illustration of an exemplary query menu GUI 1110 for a query module 1100 according to an aspect of the present disclosure. As shown, the query menu GUI 1110 may include several selectable options 1120 that may provide tools an operator may be able to use in conducting operations and addressing issue presented at an agricultural system.

The GUI 500 of FIG. 5, and modules represented in FIGS. 6A-11 accessible through the home page 510 of the GUI 500, may collectively provide a risk management agent. As provided, supported, and maintained by a risk management platform according to the present disclosure, such a risk management agent may be effectively employed by a system operator or worker for an agricultural system as a virtual field assistant. Furthermore, exemplary risk management agents described herein may be tailored through respective risk management platforms to individuals typically found in agricultural systems and technology available to those individuals in terms of communications, information availability and exchange/transfer capabilities, and equipment (e.g., seeding, harvesting, pesticide dispersion, and other types of farming equipment) for operating an agricultural system. For example, various exemplary risk management agents according to the present disclosure may be tailored to large scale farms, smallholder farms, and commercialized agricultural systems located in different types of areas including very rural difficult to reach areas (e.g., mountains in Indonesia, rural Colombia, or Ecuador). In addition, tailoring of an exemplary risk management agent may include types of profiles maintained, attributes and parameters tracked, types of assessments performed, and other aspects according to the present disclosure.

Thus, methods and systems described herein may provide exemplary risk management platforms configured to consider constraints with equatorial tree crops and other agricultural systems where, at least at an operator level, access to technology is sub-optimal. In some examples, a risk management platform according to the present disclosure may instantiate, maintain, and otherwise support a risk management agent tailored to an 18 degree band around the equator. This band may include places that tend to have limited structural availability when it comes to agricultural system management and certain technologies (limited internet access or computer access), but may be optimal locations for monitoring the presence of diseases in the public that may affect plant yield on regional and global scales.

Program aspects of the disclosed technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

A computer system, such as a system or device implementing a process or operation in the examples above, may include one or more computing devices. One or more processors of a computer system may be included in a single computing device or distributed among a plurality of computing devices. A memory of the computer system may include the respective memory of each computing device of the plurality of computing devices.

A computer may be configured as a device for executing the exemplary examples of the present disclosure. For example, the computer may be configured according to exemplary examples of this disclosure. In various examples, any of the systems herein may be a computer including, for example, a data communication interface for packet data communication. The computer also may include a central processing unit (“CPU”), in the form of one or more processors, for executing program instructions. The computer may include an internal communication bus, and a storage unit (such as ROM, HDD, SDD, etc.) that may store data on a computer readable medium, although the computer may receive programming and data via network communications. The computer may also have a memory (such as RAM) storing instructions for executing techniques presented herein, although the instructions may be stored temporarily or permanently within other modules of computer (e.g., processor and/or computer readable medium). The computer also may include input and output ports and/or a display to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Furthermore, while some examples described herein include some but not other features included in other examples, combinations of features of different examples are meant to be within the scope of the invention, and form different examples, as would be understood by those skilled in the art.

Thus, while certain examples have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for managing risks for agricultural systems, the method comprising:
receiving, by one or more processors, an agricultural system unit (ASU) selection for an ASU associated with an agroforestry agricultural system;
accessing, by the one or more processors, an analysis for a plant corresponding to the ASU selection based on a selection type of the ASU selection;
accessing, by the one or more processors, an assessment associated with the plant corresponding to the ASU selection based on the analysis and the selection type;
determining, by the one or more processors, a need for a risk mitigating technique based on the analysis and/or the assessment; and
causing, by the one or more processors, results of processing the ASU selection to be indicated in a graphical user interface (GUI) based on the selection type,
wherein plants of the agroforestry agricultural system include cocoa trees.

2. The computer-implemented method of claim 1, the method further comprising configuring, by the one or more processors, results of accessing the analysis and the assessment according to a specified format based on at least one of a location of the agroforestry agricultural system or a reporting standard.

3. The computer-implemented method of claim 1, wherein accessing the assessment includes determining a number of plants within the ASU exhibiting a disease.

4. The computer-implemented method of claim 3, wherein the disease is cocoa swollen shoot disease.

5. The computer-implemented method of claim 1, wherein accessing the assessment includes receiving an indication of a test result from a test kit.

6. The computer-implemented method of claim 1, wherein accessing the assessment includes generating a heat map including a density indicator.

7. The computer-implemented method of claim 6, wherein the density indicator is configured to indicate a number of plants included in the ASU.

8. The computer-implemented method of claim 1, wherein accessing the analysis includes:
capturing, by the one or more processors, an image of at least a portion of the ASU of the ASU selection; and
receiving, by the one or more processors, an image analysis for the image, the image analysis including a number of plant parts that are damaged within the portion of the ASU.

9. The computer-implemented method of claim 1, wherein determining the need for the risk mitigating technique includes:
determining, by the one or more processors, the risk mitigating technique includes changes to a schedule for analyzing at least one group of plants included in the agroforestry agricultural system; and
transmitting, by the one or more processors, a notification to at least one computing device, wherein the notification includes the schedule with the changes.

10. The computer-implemented method of claim 1, wherein determining the need for the risk mitigating technique includes:
accessing, by the one or more processors, historical weather information from one or more servers, the historical weather information being for an area including the agroforestry agricultural system;
determining, by the one or more processors, the risk mitigating technique includes changing a schedule for supplying of water to at least a portion of the agroforestry agricultural system based on the historical weather information.

11. The computer-implemented method of claim 1, wherein the results of processing the ASU selection include a prediction for an incidence of at least one disease in at least one group of plants in the agroforestry agricultural system over a defined future period of time, the prediction having been made using a prediction model for the agroforestry agricultural system.

12. The computer-implemented method of claim 1, wherein causing the results of processing the ASU selection to be indicated in the GUI includes causing the GUI to include a summary for the ASU, wherein the summary includes a number of plants associated with the ASU that are diseased for a single date or over a range of dates.

13. A computer system for managing risks for agricultural systems, the computer system comprising:
at least one memory storing instructions; and
at least one processor configured to execute the instructions to perform operations comprising:
receiving an agricultural system unit (ASU) selection for an ASU associated with an agroforestry agricultural system;
accessing an analysis for a plant corresponding to the ASU selection based on a selection type of the ASU selection;
accessing an assessment associated with the plant corresponding to the ASU selection based on the analysis and the selection type;
determining a need for a risk mitigating technique based on the assessments; and
causing results of processing the ASU selection to be indicated in a graphical user interface based on the selection type,
wherein plants of the agroforestry agricultural system include cocoa trees.

14. The computer system of claim 13, the operations further comprising configuring, by the at least one processor, results of accessing the analysis and the assessment according to a specified format based on at least one of a location of the agroforestry agricultural system or a reporting standard.

15. The computer system of claim 13, wherein accessing the assessment includes determining a number of plants within the ASU exhibiting a disease.

16. The computer system of claim 15, wherein the disease is cocoa swollen shoot disease.

17. The computer system of claim 15, wherein accessing the assessment includes generating a heat map including a density indicator.

18. A non-transitory computer-readable medium storing instructions that, when executed by at least one processor, cause the at least one processor to perform operations for managing risks for agricultural systems, the operations comprising:
receiving an agricultural system unit (ASU) selection for an ASU associated with an agroforestry agricultural system;
accessing an analysis for a plant corresponding to the ASU selection based on a selection type of the ASU selection;
accessing an assessment associated with the plant corresponding to the ASU selection based on the analysis and the selection type;
determining a need for a risk mitigating technique based on the assessments; and
causing results of processing the ASU selection to be indicated in a graphical user interface based on the selection type,
wherein plants of the agroforestry agricultural system include cocoa trees.

19. The non-transitory computer-readable medium of claim 18, wherein accessing the assessment includes determining a number of plants within the ASU exhibiting cocoa swollen shoot disease.

20. The non-transitory computer-readable medium of claim 18, wherein accessing the assessment includes generating a heat map including a density indicator.
